(19) United States
(12) Patent Application Publication
(10) Pub. No.: US 2026/0239122 A1
(43) Pub. Date: Aug. 13, 2026

(54) METHOD AND APPARATUS FOR HANDLING SECONDARY NODE OPERATIONS IN MULTI-RAT DUAL CONNECTIVITY

(71) Applicant: Samsung Electronics Co., Ltd., Suwon-si, Gyeonggi-do (KR)

(72) Inventors: Manasi EKKUNDI, Bangalore (IN); Neha SHARMA, Bangalore (IN); Dongmyoung KIM, Suwon-si (KR)

(21) Appl. No.: 19/155,412

(22) PCT Filed: Feb. 8, 2024
(86) PCT No.: PCT/KR2024/001942

§ 371 Date: Aug. 11, 2025

(30) Foreign Application Priority Data
Feb. 13, 2023 (IN) 202341009543
Mar. 2, 2023 (IN) 202341014248
Dec. 14, 2023 (IN) 202341009543

(51) Int. Cl. H04W 36/00; H04L 9/08

(52) U.S. Cl. CPC H04W 36/00698; H04L 9/0852; H04W 36/0038; H04L 2209/80

(57) ABSTRACT

The present disclosure relates to a 5G communication system or a 6G communication system for supporting higher data rates beyond a 4G communication system such as long term evolution (LTE). The method includes receiving at least one User Equipment (UE) capability information from at least one UE, wherein the at least one UE capability information comprises a Post Quantum Cryptography (PQC) information, transmitting an SN addition request message to at least one SN with the PQC information, based on the at least one UE capability information, receiving an SN addition request acknowledge message from the at least one SN, if PQC is supported between the at least one UE and the at least one SN, and receiving an SN addition request reject message from the at least one SN, if PQC is not supported between the at least one UE and the at least one SN.

### TECHNICAL FIELD

Embodiments disclosed herein relate to wireless communication networks, and more particularly to procedures for adding or modifying Secondary Nodes (SNs) in Multi Radio Access Technology (RAT)-Dual Connectivity (MR-DC).

### BACKGROUND ART

Considering the development of wireless communication from generation to generation, the technologies have been developed mainly for services targeting humans, such as voice calls, multimedia services, and data services. Following the commercialization of 5G (5th-generation) communication systems, it is expected that the number of connected devices will exponentially grow. Increasingly, these will be connected to communication networks. Examples of connected things may include vehicles, robots, drones, home appliances, displays, smart sensors connected to various infrastructures, construction machines, and factory equipment. Mobile devices are expected to evolve in various form-factors, such as augmented reality glasses, virtual reality headsets, and hologram devices. In order to provide various services by connecting hundreds of billions of devices and things in the 6G (6th-generation) era, there have been ongoing efforts to develop improved 6G communication systems. For these reasons, 6G communication systems are referred to as beyond-5G systems.

6G communication systems, which are expected to be commercialized around 2030, will have a peak data rate of tera (1,000 giga)-level bps and a radio latency less than 100 μsec, and thus will be 50 times as fast as 5G communication systems and have the 1/10 radio latency thereof.

In order to accomplish such a high data rate and an ultra-low latency, it has been considered to implement 6G communication systems in a terahertz band (for example, 95 GHz to 3THz bands). It is expected that, due to severer path loss and atmospheric absorption in the terahertz bands than those in mmWave bands introduced in 5G, technologies capable of securing the signal transmission distance (that is, coverage) will become more crucial. It is necessary to develop, as major technologies for securing the coverage, radio frequency (RF) elements, antennas, novel waveforms having a better coverage than orthogonal frequency division multiplexing (OFDM), beamforming and massive multiple input multiple output (MIMO), full dimensional MIMO (FD-MIMO), array antennas, and multiantenna transmission technologies such as large-scale antennas. In addition, there has been ongoing discussion on new technologies for improving the coverage of terahertz-band signals, such as metamaterial-based lenses and antennas, orbital angular momentum (OAM), and reconfigurable intelligent surface (RIS).

Moreover, in order to improve the spectral efficiency and the overall network performances, the following technologies have been developed for 6G communication systems: a full-duplex technology for enabling an uplink transmission and a downlink transmission to simultaneously use the same frequency resource at the same time; a network technology for utilizing satellites, high-altitude platform stations (HAPS), and the like in an integrated manner; an improved network structure for supporting mobile base stations and the like and enabling network operation optimization and automation and the like; a dynamic spectrum sharing technology via collison avoidance based on a prediction of spectrum usage; an use of artificial intelligence (AI) in wireless communication for improvement of overall network operation by utilizing AI from a designing phase for developing 6G and internalizing end-to-end AI support functions; and a next-generation distributed computing technology for overcoming the limit of UE computing ability through reachable super-high-performance communication and computing resources (such as mobile edge computing (MEC), clouds, and the like) over the network. In addition, through designing new protocols to be used in 6G communication systems, developing mechanisms for implementing a hardware-based security environment and safe use of data, and developing technologies for maintaining privacy, attempts to strengthen the connectivity between devices, optimize the network, promote softwarization of network entities, and increase the openness of wireless communications are continuing.

It is expected that research and development of 6G communication systems in hyperconnectivity, including person to machine (P2M) as well as machine to machine (M2M), will allow the next hyper-connected experience. Particularly, it is expected that services such as truly immersive extended reality (XR), high-fidelity mobile hologram, and digital replica could be provided through 6G communication systems. In addition, services such as remote surgery for security and reliability enhancement, industrial automation, and emergency response will be provided through the 6G communication system such that the technologies could be applied in various fields such as industry, medical care, automobiles, and home appliances.

### DISCLOSURE OF INVENTION

### Technical Problem

The principal object of embodiments herein is to disclose methods and systems for handling Secondary Node (SN) procedures in Multi Radio Access Technology (RAT)-Dual Connectivity (MR-DC).

Another object of embodiments herein is to disclose procedures for adding or modifying SNs in next generation networks (for example, Sixth Generation (6G) networks).

Another object of the embodiments herein is to disclose procedures for adding or modifying SNs in Sixth Generation (6G) networks, wherein PQC related security aspects are disclosed when adding SNs.

Another object of the embodiments herein is to disclose procedures for adding or modifying SNs in 6G networks, wherein the PQC related security aspects are disclosed when modifying SNs.

Another object of embodiments herein is to disclose methods and systems for handling SN procedures based on the type of security algorithm supported in User Equipment (UE) and network.

Another object of the embodiments herein is to disclose procedures for adding SNs in 6G networks, wherein Primary and Secondary Cells (PSCells) can be added conditionally with PQC support.

Another object of the embodiments herein is to disclose methods and systems for performing SN addition, SN modification, and conditional SN addition procedures to handle Non Standalone (NSA) option when next generation RAT is introduced.

Another object of the embodiments herein is to disclose methods and systems for performing SN procedures to handle new and improved security algorithms that are quantum computational capabilities resistant.

Another object of the embodiments herein is to disclose procedures and information elements that need to be included in order to handle the 6G Radio Access Network (RAN) node as a secondary node in SN modification procedures.

### Solution to Problem

Accordingly, the embodiments herein provide a method for handling Secondary Node (SN) addition in Multi Radio Access Technology (RAT)-Dual Connectivity (MR-DC) performed by a Master Node (MN) in a wireless communication system. The method comprises receiving at least one User Equipment (UE) capability information from at least one UE. The UE capability information comprises a Post Quantum Cryptography (PQC) information. The method comprises sending an SN addition request message to at least one SN with the PQC information, based on the UE capability information. The method comprises receiving an SN addition request acknowledge message from the SN, if PQC is supported between the UE and the SN. Thereafter, the method comprises receiving an SN addition request reject message from the SN, if PQC is not supported between the UE and the SN.

Accordingly, the embodiments herein provide a MN of a network. The MN comprises a processor which is configured to receive at least one UE capability information from at least one UE. The processor is configured to send an SN addition request message to at least one SN with the PQC information, based on the UE capability information. The processor is configured to receive an SN addition request acknowledge message from the SN, if PQC is supported between the UE and the SN. Further, the processor is configured to receive an SN addition request reject message from the SN, if PQC is not supported between the UE and the SN.

Accordingly, the embodiments herein provide a method for handling SN addition in MR-DC. The method comprises measuring, by a UE, one or more node parameters of one or more SNs for adding at least one SN based on service requirements. The method comprises selecting, by the UE, the SN with strong cells from one or more SNs, based on the measured one or more node parameters. Thereafter the MN, with its MN ID indicates to the selected SN ID, that the UE has requested to add the SN. The method comprises receiving, by the UE, a Radio Resource Control (RRC) reconfiguration message with a network data and one or more security parameters of the SN, from the MN. Thereafter, the method comprises initiating, by the UE, a Random Access Channel (RACH) procedure, for the selected SN. The SN sends an indication to the MN related to the MN ID that the UE has requested to add the SN.

Accordingly, the embodiments herein provide a UE comprising a processor. The processor is configured to measure one or more node parameters of one or more SNs for adding SN based on service requirements. The processor is configured to select the SN with strong cells from one or more SNs, based on the measured node parameters. The processor is configured to receive a RRC reconfiguration message with a network data and one or more security parameters of the SN, from the MN. Further, the processor is configured to initiate a RACH procedure for the selected SN.

Accordingly, the embodiments herein provide a method for handling SN modification in MR-DC. The method comprises receiving, by a MN of a network, at least one UE capability information from at least one UE. The UE capability information comprises a PQC information. The method comprises sending, by the MN, an SN modification request message to at least one SN with the PQC information, based on the UE capability information. The method comprises receiving, by the MN, an SN modification request acknowledge message from the SN, if PQC is supported between the UE and the SN. The method comprises receiving, by the MN, an SN modification request reject message from the SN, if PQC is not supported between the UE and the SN.

Accordingly, the embodiments herein provide a MN of a network. The MN comprises a processor which is configured to receive at least one UE capability information from at least one UE. The processor is configured to send an SN modification request message to at least one SN with the PQC information, based on the UE capability information. The processor is configured to send receive an SN modification request acknowledge message from the SN, if PQC is supported between the UE and the SN. Further, the processor is configured to receive an SN modification request reject message from the SN, if PQC is not supported between the UE and the SN.

These and other aspects of the example embodiments herein will be better appreciated and understood when considered in conjunction with the following description and the accompanying drawings. It should be understood, however, that the following descriptions, while indicating example embodiments and numerous specific details thereof, are given by way of illustration and not of limitation. Many changes and modifications may be made within the scope of the example embodiments herein without departing from the spirit thereof, and the example embodiments herein include all such modifications.

### BRIEF DESCRIPTION OF DRAWINGS

Embodiments herein are illustrated in the accompanying drawings, throughout which like reference letters indicate corresponding parts in the various figures. The embodiments herein will be better understood from the following description with reference to the following illustratory drawings. Embodiments herein are illustrated by way of examples in the accompanying drawings, and in which:

FIGS. 1a and 1b illustrate Control plane (C-plane) connectivity between a Master node (MN) and a Secondary Node (SN) in Multi Radio Access Technology (RAT)-Dual Connectivity (MR-DC), according to existing arts;

FIGS. 2a and 2b illustrate a User plane (U-plane) connectivity between MN and SN in MR-DC, according to existing arts;

FIGS. 3a, 3b, and 3c show various deployment options, with introduction of 6G Radio Access Technology (RAT), according to existing arts;

FIG. 4 illustrates a Secondary gNodeb (SgNB) addition procedure in E-UTRAN NR Dual Connectivity (ENDC), according to existing arts;

FIG. 5 illustrates a SN addition procedure in MR-DC with 5G core network, according to existing arts;

FIG. 6 illustrates a Conditional PSCell Addition (CPA) procedure, according to existing arts;

FIG. 7 illustrates a system indicating communication between at least one UE and a network for handling SN operations in MR-DC, according to embodiments as disclosed herein;

FIG. 8 illustrates a plurality of modules of MN, according to embodiments as disclosed herein;

FIG. 9 illustrates a plurality of modules of SN, according to embodiments as disclosed herein;

FIG. 10 illustrates a plurality of modules of a processor of UE, according to embodiments as disclosed herein;

FIG. 11 illustrates a method for handling an SN addition in MR-DC by the MN, according to embodiments as disclosed herein;

FIG. 12 illustrates a message sequence diagram indicating PQC related security aspects in SN addition procedure with 5GC, according to embodiments as disclosed herein;

FIG. 13 illustrates a message sequence diagram indicating PQC related security aspects in SN addition procedure with Evolved Packet Core (EPC), according to embodiments as disclosed herein;

FIG. 14 illustrates a flowchart for evaluating PQC information at SN, according to embodiments as disclosed herein;

FIG. 15 illustrates a method of CPA procedure with PQC support table by the MN, according to embodiments as disclosed herein;

FIG. 16 illustrates a message sequence diagram indicating a CPA procedure using the PQC support table, according to embodiments as disclosed herein;

FIG. 17 illustrates a method of UE initiated SN addition procedure, according to embodiments as disclosed herein;

FIG. 18 illustrates a message sequence diagram indicating a UE initiated SN addition procedure, according to embodiments as disclosed herein;

FIG. 19 illustrates a method for handling SN modification in MR-DC, according to embodiments as disclosed herein;

FIG. 20 illustrates a message sequence diagram indicating PQC related security aspects in SN modification procedure for deployment option of NSA with 5GC, according to embodiments as disclosed herein;

FIG. 21 illustrates a message sequence diagram indicating PQC related security aspects in S6gNB modification procedure with EPC, according to embodiments as disclosed herein;

FIG. 22a illustrates a method for evaluating PQC information at SN based on SN modification request message, according to embodiments as disclosed herein;

FIG. 22b illustrates a method of implementing step 1 of FIG. 22a, according to embodiments as disclosed herein; and

FIG. 22c illustrates a method of implementing step 2 of FIG. 22a, according to embodiments as disclosed herein.

### MODE FOR THE INVENTION

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

For the purposes of interpreting this specification, the definitions (as defined herein) will apply and whenever appropriate the terms used in singular will also include the plural and vice versa. It is to be understood that the terminology used herein is for the purposes of describing particular embodiments only and is not intended to be limiting. The terms “comprising”, “having” and “including” are to be construed as open-ended terms unless otherwise noted.

The words/phrases “exemplary”, “example”, “illustration”, “in an instance”, “and the like”, “and soon”, “etc.”, “etcetera”, “e.g.,”, “i.e.,” are merely used herein to mean “serving as an example, instance, or illustration.” Any embodiment or implementation of the present subject matter described herein using the words/phrases “exemplary”, “example” “illustration”, “in an instance”, “and the like”, “and so on”, “etc.”, “etcetera”, “e.g.,”, “i.e.,” is not necessarily to be construed as preferred or advantageous over other embodiments.

Embodiments herein may be described and illustrated in terms of blocks which carry out a described function or functions. These blocks, which may be referred to herein as managers, units, modules, hardware components or the like, are physically implemented by analog and/or digital circuits such as logic gates, integrated circuits, microprocessors, microcontrollers, memory circuits, passive electronic components, active electronic components, optical components, hardwired circuits and the like, and may optionally be driven by a firmware. The circuits may, for example, be embodied in one or more semiconductor chips, or on substrate supports such as printed circuit boards and the like. The circuits constituting a block may be implemented by dedicated hardware, or by a processor (e.g., one or more programmed microprocessors and associated circuitry), or by a combination of dedicated hardware to perform some functions of the block and a processor to perform other functions of the block. Each block of the embodiments may be physically separated into two or more interacting and discrete blocks without departing from the scope of the disclosure. Likewise, the blocks of the embodiments may be physically combined into more complex blocks without departing from the scope of the disclosure.

It should be noted that elements in the drawings are illustrated for the purposes of this description and ease of understanding and may not have necessarily been drawn to scale. For example, the flowcharts/sequence diagrams illustrate the method in terms of the steps required for understanding of aspects of the embodiments as disclosed herein. Furthermore, in terms of the construction of the device, one or more components of the device may have been represented in the drawings by conventional symbols, and the drawings may show only those specific details that are pertinent to understanding the present embodiments so as not to obscure the drawings with details that will be readily apparent to those of ordinary skill in the art having the benefit of the description herein. Furthermore, in terms of the system, one or more components/modules which comprise the system may have been represented in the drawings by conventional symbols, and the drawings may show only those specific details that are pertinent to understanding the present embodiments so as not to obscure the drawings with details that will be readily apparent to those of ordinary skill in the art having the benefit of the description herein.

The accompanying drawings are used to help easily understand various technical features and it should be understood that the embodiments presented herein are not limited by the accompanying drawings. As such, the present disclosure should be construed to extend to any modifications, equivalents, and substitutes in addition to those which are particularly set out in the accompanying drawings and the corresponding description. Usage of words such as first, second, third etc., to describe components/elements/steps is for the purposes of this description and should not be construed as sequential ordering/placement/occurrence unless specified otherwise.

Wireless technology has been continuously evolving over the years to provide for the growing demand of services and requirements of end users. The earliest generation called as the second generation of wireless communication provided mobility and voice services while the third generation provided for voice and data services. However with growing demand for high speed data, there was a need to further evolve and fourth generation of wireless communication was developed. In the fourth generation communication system, multiple architecture options were designed to provide high speed data. These systems include aggregation of multiple carriers either through carrier aggregation (CA) or through dual connectivity (DC) which allowed operators to provide high data rates per user through aggregation of their radio resources.

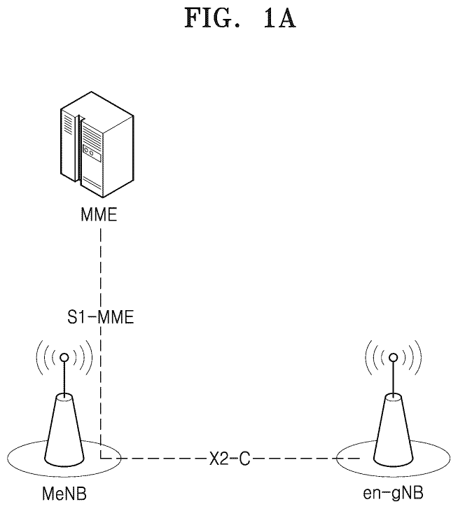

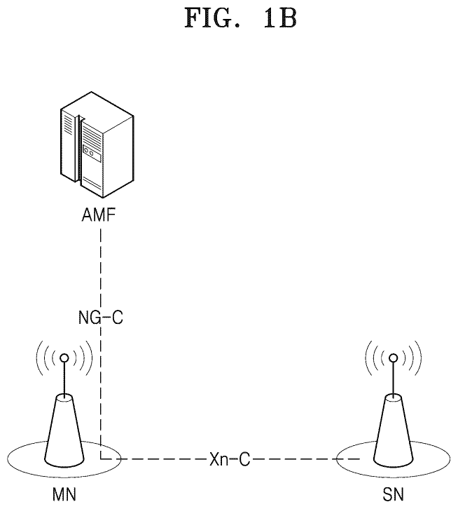

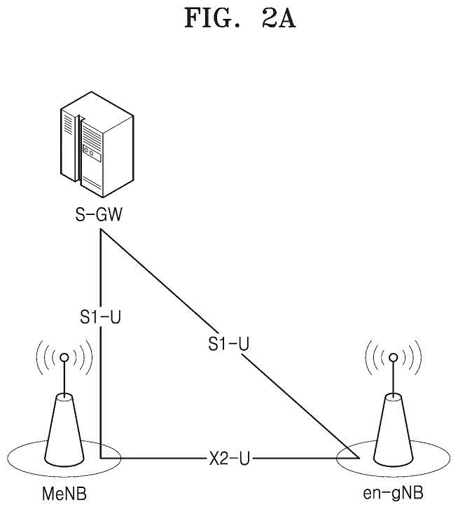

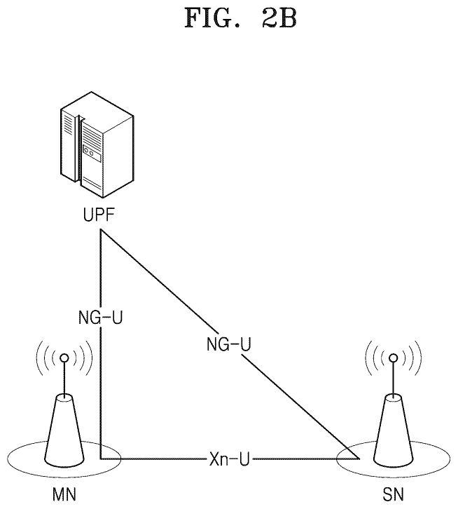

However due to the growing demand of high speed data, even with the advances in fourth generation technology like CA or DC was not sufficient to help the growing demands. Hence, fifth generation wireless communication system was designed. New radio spectrum in the high frequency band called the Millimeter Wave (mmWave) and mid frequency band spectrum has been under usage. With the deployment of new radio spectrum and to ensure early deployment of the fifth generation technology, E-UTRAN NR Dual Connectivity (ENDC) found popular usage and deployment across the globe. Fifth generation technology also defined as multiple dual connectivity options that provided operators across the globe flexibility to deploy as per their business and user needs. Multi Radio Access Technology (RAT) Dual Connectivity (MR-DC) is a generalized concept of Intra EUTRA Dual Connectivity where multiple receiver/transmitter User Equipment (UE) is configured to utilize resources over two different nodes via non ideal backhaul. FIGS. 1a and 1b illustrate Control plane (C-plane) connectivity between a Master node (MN) and a Secondary Node (SN) in MR-DC. FIGS. 2a and 2b illustrate User plane (U-plane) connectivity between MN and SN in MR-DC.

Fifth generation also promises to deliver ultra-reliable low latency and machine type communication along with enhanced mobile broadband usages. With the wide variety of use cases possible in fifth generation, there is a growing need to find sustainable, immersive, intelligent, secure infrastructure to provide next generation services and requirements that can sustain current use cases and enable new use cases.

For the next generation of wireless communication systems (for example, 6G), various technologies have been under consideration, for example, Visible Light Communication (VLC), Terahertz band (THz) (i.e., frequencies from 100 GHz to 3THz), Infrared wave and Ultraviolet wave, and so on. Among all these technologies, the THz band is envisioned as a potential technology for a diverse range of applications, which exist within the nano, micro as well as macro scales. The various features of the THz band include such as terabits per second (Tbps) data rates, reliable transmission, and minimal latency.

Frequencies from 100 GHz to 3THz are promising bands for the next generation of wireless communication systems because of the wide range of the unused and unexplored spectrum. As per the literature available for THz band communication system, these frequencies also offer the potential for revolutionary applications in the realm of devices, circuits, software, signal processing, and systems. The ultra-high data rates facilitated by mmWave and THz wireless local area and cellular networks enable super-fast download speeds for computer communication, autonomous vehicles, robotic controls, information shower, high-definition holographic gaming, entertainment, video conferencing, and high-speed wireless data distribution in data centers. In addition to the extremely high data rates, there are promising applications for future mmWave and THz systems that are likely to evolve in 6G networks, and beyond. It is also likely that in 6G, to look for sustainable growth, spectrum in Sub-7 Ghz and new spectrum in 7 Ghz to 24 Ghz might find usage along with the THz spectrum.

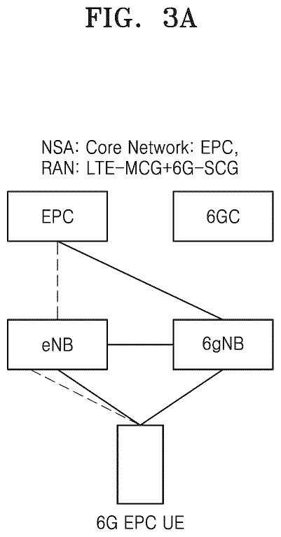

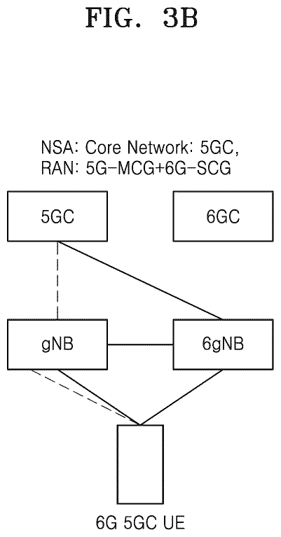

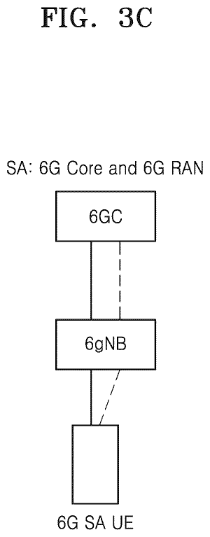

In 6G, depending on the use cases, cost, complexity, scalability etc., reuse of existing deployment options may be possible or new deployment options that were not standardized for 5G may also be required. FIGS. 3a, 3b, and 3c show various such deployment options, with introduction of 6G Radio Access Technology (RAT).

There are multiple options for 6G deployments for existing Non-Standalone (NSA) and Standalone (SA) architecture options and new NSA architecture options. Following are the possible (not limited to) 6G network architecture options:
NSA: Core Network: EPC, RAN: LTE−MCG+6G−SCG
NSA: Core Network: 5GC, RAN: NR−MCG+6G−SCG

With the introduction of the 6G RAT, it is necessary to define changes/additions that can occur in UE procedures for SN addition and inter-node procedures for SN addition. SN addition procedures currently defined in 3gpp specification include:
Blind/Measurement based SN addition/modification; and
Conditional Primary and Secondary Cell (PSCell) Addition.

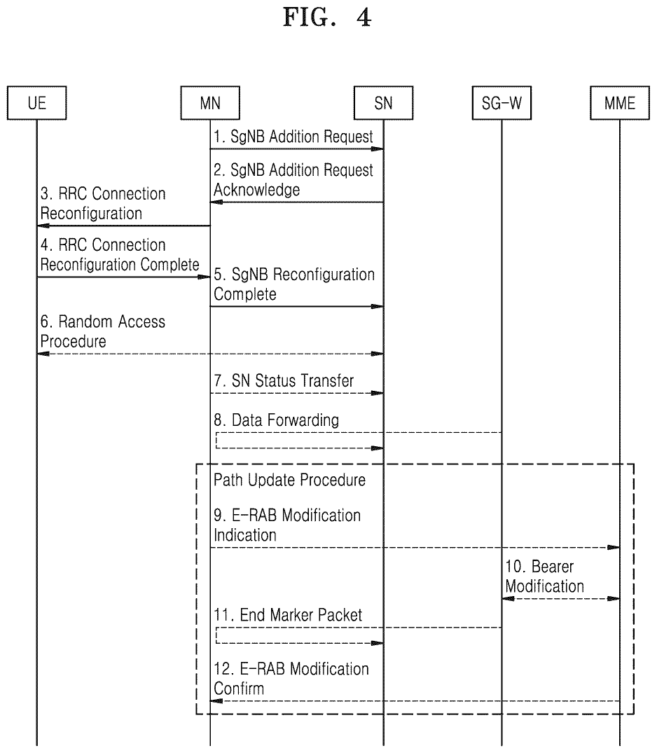

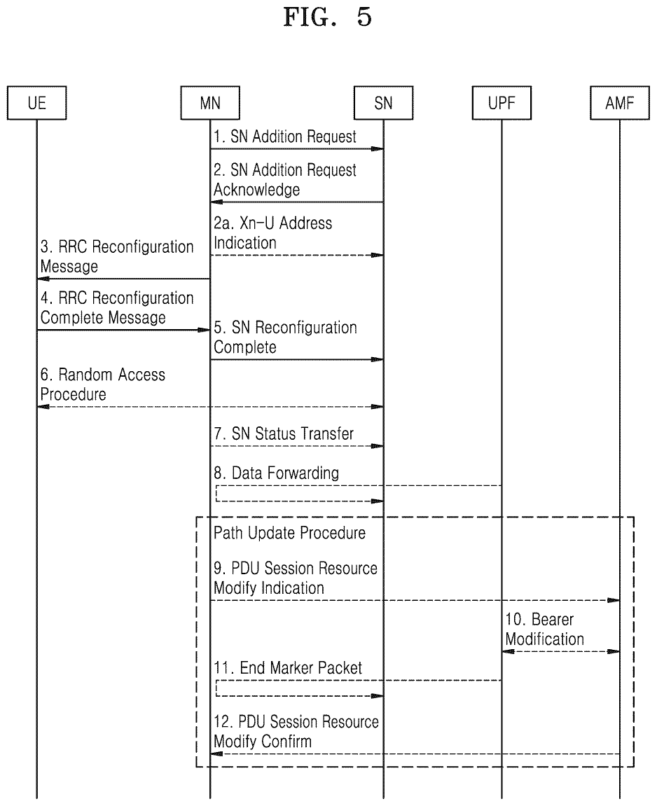

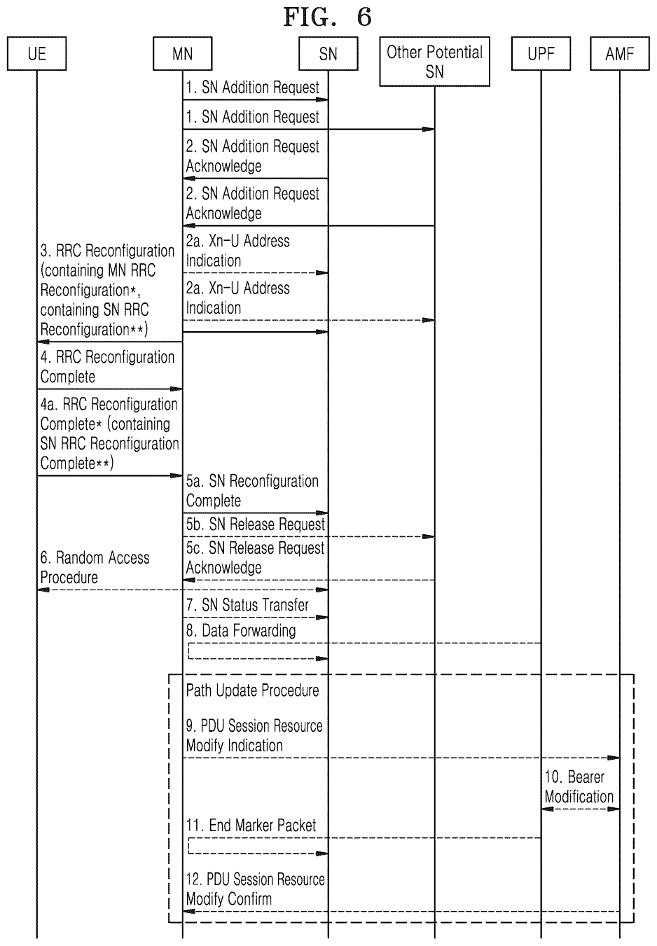

FIG. 4 illustrates a Secondary gNodeb (SgNB) addition procedure in ENDC. FIG. 5 illustrates a SN addition procedure in MR-DC with 5G core network. The SN addition procedure is initiated by the MN and is used to establish a UE context at the SN to provide resources from the SN to the UE. For bearers requiring Secondary Cell Group (SCG) radio resources, this procedure is used to add at least a first cell of the SCG. The procedures shown in FIG. 4 and FIG. 5 are captured in 3GPP TS 37.340 and separate procedures exist for SN addition for ENDC and SN addition for MR-DC with 5G core network. FIG. 6 illustrates a Conditional PSCell Addition (CPA) procedure. The CPA is defined as a PSCell addition that is executed by the UE when execution condition(s) is met. The UE starts evaluating the execution condition(s) upon receiving the CPA configuration, and stops evaluating the execution condition(s) once PSCell addition or PCell change is triggered. In case of CPA, the Conditional SN Addition procedure can be used for CPA configuration and CPA execution. The CPA configuration contains the configuration of CPA candidate PSCell(s), execution condition(s) and may contain the Master Cell Group (MCG) configuration, to be applied when CPA execution is triggered.

Quantum computers are machines that use quantum mechanical phenomena to solve mathematical problems that are hard to solve by a conventional computer. Such quantum computers are capable of breaking traditional cryptographic algorithms and if such systems are deployed in digital and communication systems, then it becomes imperative to develop quantum computer resistant cryptographic algorithms for enabling security in future communication systems. Post Quantum Cryptography (PQC) refers to a set of algorithms that are considered to be safe and provide security even for quantum computers which is not possible with legacy algorithms, and can be used in 6G network. Therefore, procedures for handling next generation wireless communication system are required in Non Standalone mode of operation when PQC algorithms are used.

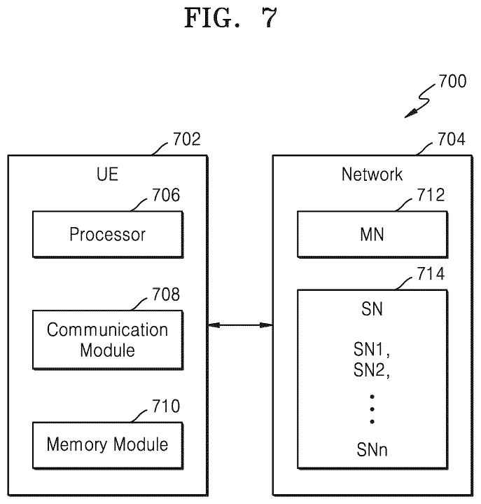

The embodiments herein achieve Secondary Node (SN) addition, SN modification, and conditional SN addition procedures to handle Non Standalone (NSA) option when Next Generation (NG) (for example, 6G) Radio Access Technology (RAT) is introduced. The procedures are designed to handle new and improved security algorithms that are quantum computational capabilities resistant. Referring now to the drawings, and more particularly to FIGS. 7 through 22c, where similar reference characters denote corresponding features consistently throughout the figures, there are shown embodiments.

FIG. 7 illustrates a system 700 indicating communication between at least one User Equipment (UE) 702 and a network 704 for handling Secondary Node (SN) procedures in Multi Radio Access Technology (RAT)-Dual Connectivity (MR-DC). The system 700 comprises at least one UE 702 and the network 704. The UE 702 further comprises a processor 706, a communication module 708, and a memory module 710. The network 704 further comprises a Master Node (MN) 712, and one or more Secondary Node (SN) 714 (For example, SN1, SN2 . . . SNn).

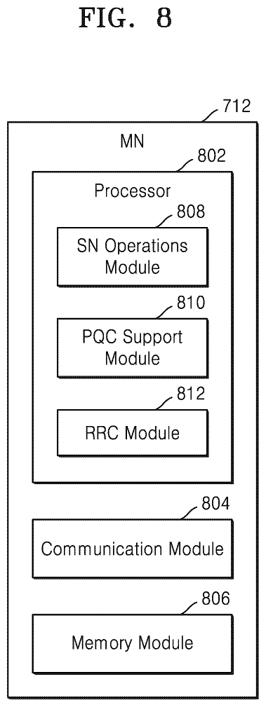

In an embodiment herein, the MN 712 further comprises a processor 802, a communication module 804, and a memory module 806, as depicted in FIG. 8. The processor 802 comprises an SN operations module 808, a PQC support module 810, and an RRC module 812. The SN operations module 808 can receive at least one UE capability information from at least one UE 702. The UE capability information comprises a Post Quantum Cryptography (PQC) information. The SN operations module 808 can send an SN addition request message or an SN modification request message to at least one SN 714 with the PQC information, based on the UE capability information. The SN addition request message or the SN modification request message comprises information of one or more candidate cells. The information of the candidate cells comprises measurement results of one or more node parameters of one or more SNs 714 for choosing and configuring at least one SN. In an embodiment herein, the SN addition request message or the SN modification request message comprises the UE capability information and a UE capability co-ordination result. The UE capability information comprises RAT information including 6G RAT. Thus, the UE capability and the UE capability co-ordination result can be sent from the MN 712 to the SN 714 or Secondary Cell Group (SCG).

In an embodiment herein, the PQC information comprises at least one PQC support, and at least one PQC profile or associated PQC parameters. The PQC support indicates whether the UE 702 supports at least one of PQC, a legacy security method, and both PQC and the legacy security method. The PQC profile or associated PQC parameters indicates if a relevant mechanism is supported at the UE 702 side for the PQC support. In an embodiment herein, the legacy security method can comprise, but not limited to, at least one security support for the SNs 714 of the network 704. The security support can comprise, but not limited to, one or more security capabilities and one or more security keys.

In an embodiment herein, the SN operations module 808 can receive an SN addition request acknowledge message or an SN modification request acknowledge message from the SN 714, if PQC is supported between the UE 702 and the SN 714. In an embodiment herein, the SN operations module 808 can receive an SN addition request reject message or an SN modification request reject message from the SN 714, if PQC is not supported between the UE 702 and the SN 714.

In an embodiment herein, the PQC support module 810 is configured with a PQC support table. The PQC support table is configured and maintained at MN 712 to evaluate the PQC information between the UE 702 and at least one SN 714 by the PQC support module 810. The PQC support table comprises one or more values indicating the PQC information between the UE 702 and the SN 714. In an embodiment herein, the PQC support module 810 can evaluate the PQC support table for one or more SNs 714, for executing a Conditional Primary and Secondary Cell (PSCell) Addition (CPA) procedure. The MN 712 can transmit at least one SN addition request message or at least one SN modification request message to the SN 714, through the SN operations module 808, based on the evaluation. The SN operations module 808 can receive at least one SN addition request acknowledge message or at least one SN modification request acknowledge message for the SN addition request message or the SN modification request message.

In an embodiment herein, the RRC module 812 can transmit a Radio Resource Control (RRC) reconfiguration message including information of one or more SNs 714 for the received SN addition request acknowledge message, to the UE 702 for enabling the UE 702 to evaluate a conditional configuration for the SNs 714. The RRC module 812 can send the RRC reconfiguration message with a network data and one or more security parameters to the UE 702, after receiving the SN addition request acknowledge message or the SN modification request acknowledge message from the SN 714. The SN addition request acknowledge message or the SN modification request acknowledge message can include, but not limited to, an RRC reconfiguration information related to at least one SN 714 of the network 704, and a global cell identity of the SN 714 of the network 704 for executing the CPA procedure by the UE 702. The RRC module 812 can receive an RRC reconfiguration complete message from the UE 702, after completion of reconfiguration based on the network data and the security parameters.

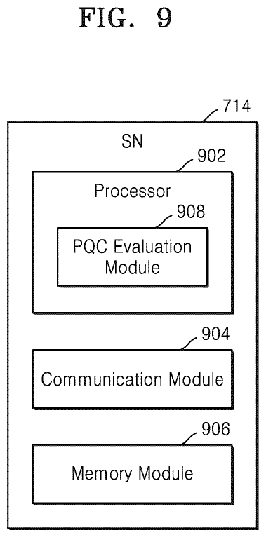

In an embodiment herein, the SN 714 further comprises a processor 902, a communication module 904, and a memory module 906, as depicted in FIG. 9. The processor 902 comprises a PQC evaluation module 908. In an embodiment herein, the PQC evaluation module 908 can receive the SN addition request message or the SN modification request message from the SN operations module 808 of the MN 712 with the PQC information, based on the UE capability information. The PQC evaluation module 908 can evaluate the PQC information between the UE 702 and at least one SN 714 from the received SN addition request message or the SN modification request message. The PQC evaluation module 908 can determine if the UE 702 supports PQC. The PQC evaluation module 908 can verify if the SN 714 supports PQC when the UE 702 supports PQC. The PQC evaluation module 908 can send an SN addition request acknowledge message or an SN modification request acknowledge message with a PQC security method to the SN operations module 808 of the MN 712, if both the UE 702 and the SN 714 supports PQC. The SN addition request acknowledge message or the SN modification request acknowledge message can include, but not limited to, an RRC reconfiguration information related to at least one SN 714 of the network 704, and a global cell identity of the SN 714 of the network 704 for executing the CPA procedure by the UE 702. The PQC evaluation module 908 can transmit the PQC profile or associated PQC parameters to the MN 712 to be utilized by the UE 702, when PQC is supported between the UE 702 and the SN 714. In an embodiment herein, the PQC evaluation module 908 can send the SN addition request acknowledge message or the SN modification request acknowledge message with the legacy security method, if the UE 702 supports PQC and the legacy security method, and the SN 714 does not support PQC. In an embodiment herein, the PQC evaluation module 908 can send the SN addition request reject message or the SN modification request reject message to the SN operations module 808 of the MN 712, if the UE 702 supports PQC and the SN 714 supports the legacy security method.

In an embodiment herein, the PQC evaluation module 908 can determine if the UE 702 supports PQC. The PQC evaluation module 908 can verify if the SN 714 supports the legacy security method, when the UE 702 does not support PQC. The PQC evaluation module 908 can send the SN addition request acknowledge message or the SN modification request acknowledge message with the legacy security method, if the UE 702 does not support PQC and the SN 714 supports the legacy security method. The PQC evaluation module 908 can send the SN addition request reject message or the SN modification request reject message, if the UE 702 does not support PQC and the SN 714 does not support the legacy security method.

In an embodiment herein, the PQC evaluation module 908 can update one or more security parameters, after evaluation. For example, the security parameters can include, but not limited to a PQC algorithm, key length, security level, other security parameters, and so on.

In an embodiment herein, the PQC evaluation module 908 can be configured and maintained with the PQC support table to evaluate the PQC information between the UE 702 and the SN 714. The PQC support table comprises one or more values indicating the PQC information between the UE 702 and the SN 714.

In an embodiment herein, the communication module 904 of the SN 714 can receive a Random Access Channel (RACH) initiation information from the UE 702.

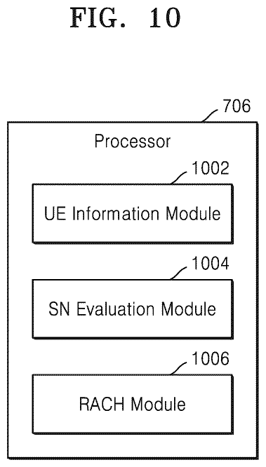

In an embodiment herein, the processor 706 further comprises a UE information module 1002, a SN evaluation module 1004, and a RACH module 1006, as depicted in FIG. 10. In an embodiment herein, the UE information module 1002 can send at least one UE capability information to the SN operations module 808 of the MN 712. The UE capability information comprises PQC information. The UE capability information comprises a RAT information including 6G RAT.

In an embodiment herein, the SN evaluation module 1004 can receive an RRC reconfiguration message, from the RRC module 812 of the MN 712, including information of one or more SNs 714 for enabling the UE 702 to evaluate a conditional configuration for one or more SNs 714. The conditional configuration comprises one or more conditional event related parameters of the RAT of the network 704 that are needed to trigger the CPA procedure at UE side. For example, a conditional event is a measurement event that is configured with certain conditions to be met for the UE 702 to automatically add a SN 714. The conditional event related parameters can be, but not limited to conditional event ID, hysteresis, time to trigger, and so on. The SN evaluation module 1004 can evaluate one or more security parameters of at least one SN 714 to match with a PQC capability of the UE 702. The SN evaluation module 1004 can determine if evaluation of the conditional configuration is required for the respective SNs 714. The SN evaluation module 1004 can evaluate a conditional configuration for the SNs 714, if the conditional configuration is required. The SN evaluation module 1004 can connect to a desired at least one SN 714 if the evaluated conditions are met.

In an embodiment herein, the RACH module 1006 can measure one or more node parameters of one or more SNs 714 for adding at least one SN based on service requirements. The MN 712 can configure all measurement objects available in one or more SNs 714. The UE 702 is aware of its service or data requirements. The RACH module 1006 can select at least one SN with strong cells from one or more SNs 714, based on the measured node parameters. Thereafter the MN 712, with its MN ID indicates to the selected SN ID, that the UE 702 has requested to add the SN 714. The RACH module 1006 can receive a RRC reconfiguration message with a network data and one or more security parameters of the SN 714, from the MN 712. The RACH module 1006 can initiate a RACH procedure for the selected SN. The SN 714 can send an indication to the MN 712 related to the MN ID that the UE 702 has requested to add the SN 714.

In an embodiment herein, the processor 706, the processor 802, and the processor 902 can process and execute data of a plurality of modules of the UE 702, MN 712, and one or more SNs 714 respectively. The processor 706, processor 802, and the processor 902 can be configured to execute instructions stored in the memory module 710, memory module 806, and memory module 906 respectively. The processor 706, processor 802, and processor 902 may comprise one or more of microprocessors, circuits, and other hardware configured for processing. The processor 706, processor 802, and processor 902 can be at least one of a single processer, a plurality of processors, multiple homogeneous or heterogeneous cores, multiple Central Processing Units (CPUs) of different kinds, microcontrollers, special media, and other accelerators. The processor 706, processor 802, and processor 902 may be an application processor (AP), a graphics-only processing unit (such as a graphics processing unit (GPU), a visual processing unit (VPU)), and/or an Artificial Intelligence (AI)-dedicated processor (such as a neural processing unit (NPU)).

In an embodiment herein, the plurality of modules of the processor 706 of the UE 702, processor 802 of the MN 712, and processor 902 of the SN 714 can communicate via the communication module 708, communication module 804, and communication module 904 respectively. The communication between, the UE 702, the MN 712, and one or more SNs 714 is carried out through the communication module 708, the communication module 804 and the communication module 904. The communication module 708, the communication module 804 and the communication module 904 may be in the form of either a wired network or a wireless communication network module. The wireless communication network may comprise, but not limited to, Global Positioning System (GPS), Global System for Mobile Communications (GSM), Wi-Fi, Bluetooth low energy, Near-field communication (NFC), and so on. The wireless communication may further comprise one or more of Bluetooth, ZigBee, a short-range wireless communication (such as Ultra-Wideband (UWB)), and a medium-range wireless communication (such as Wi-Fi) or a long-range wireless communication (such as 3G/4G/5G/6G and non-3GPP technologies or WiMAX), according to the usage environment.

In an embodiment herein, the memory module 710, the memory module 806, and the memory module 906 may comprise one or more volatile and non-volatile memory components which are capable of storing data and instructions of the modules of the UE 702, the MN 712, and one or more SNs 714 to be executed. Examples of the memory module 710, the memory module 806, and the memory module 906 can be, but not limited to, NAND, embedded Multi Media Card (eMMC), Secure Digital (SD) cards, Universal Serial Bus (USB), Serial Advanced Technology Attachment (SATA), solid-state drive (SSD), and so on. The memory module 710, the memory module 806, and the memory module 906 may also include one or more computer-readable storage media. Examples of non-volatile storage elements may include magnetic hard discs, optical discs, floppy discs, flash memories, or forms of electrically programmable memories (EPROM) or electrically erasable and programmable (EEPROM) memories. In addition, the memory module 710, the memory module 806, and the memory module 906 may, in some examples, be considered a non-transitory storage medium. The term “non-transitory” may indicate that the storage medium is not embodied in a carrier wave or a propagated signal. However, the term “non-transitory” should not be interpreted to mean that the memory module 710, the memory module 806, and the memory module 906 is non-movable. In certain examples, a non-transitory storage medium may store data that can, over time, change (for example, in Random Access Memory (RAM) or cache).

FIG. 7 shows example modules of the UE 702 and the network 704 respectively, but it is to be understood that other embodiments are not limited thereon. In other embodiments, the UE 702 and the network 704 may include less or more number of modules. Further, the labels or names of the modules are used only for illustrative purpose and does not limit the scope of the invention. One or more modules can be combined together to perform same or substantially similar function in the UE 702 and the network 704.

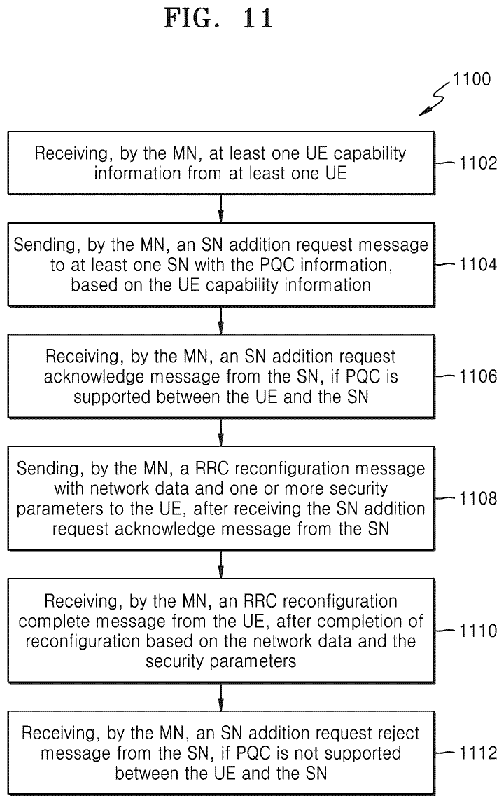

FIG. 11 illustrates a method 1100 for handling an SN addition in MR-DC by the MN 712. The method 1100 comprises receiving, by the MN 712, at least one UE capability information from at least one UE 702, as depicted in step 1102. The UE capability information comprises PQC information. The method 1100 comprises sending, by the MN 712, an SN addition request message to at least one SN 714 with the PQC information, based on the UE capability information, as depicted in step 1104. The method 1100 comprises receiving, by the MN 712, an SN addition request acknowledge message from the SN 714, if PQC is supported between the UE 702 and the SN 714, as depicted in step 1106.

The method 1100 comprises sending, by the MN 712, the RRC reconfiguration message with a network data and one or more security parameters to the UE 702, after receiving the SN addition request acknowledge message from the SN 714, as depicted in step 1108. The method 1100 comprises receiving, by the MN 712, an RRC reconfiguration complete message from the UE 702, after completion of reconfiguration based on the network data and the security parameters, as depicted in step 1110. Further, the method 1100 comprises receiving, by the MN 712, an SN addition request reject message from the SN 714, if PQC is not supported between the UE 702 and the SN 714, as depicted in step 1112.

The various actions in method 1100 may be performed in the order presented, in a different order or simultaneously. Further, in some embodiments, some actions listed in FIG. 11 may be omitted.

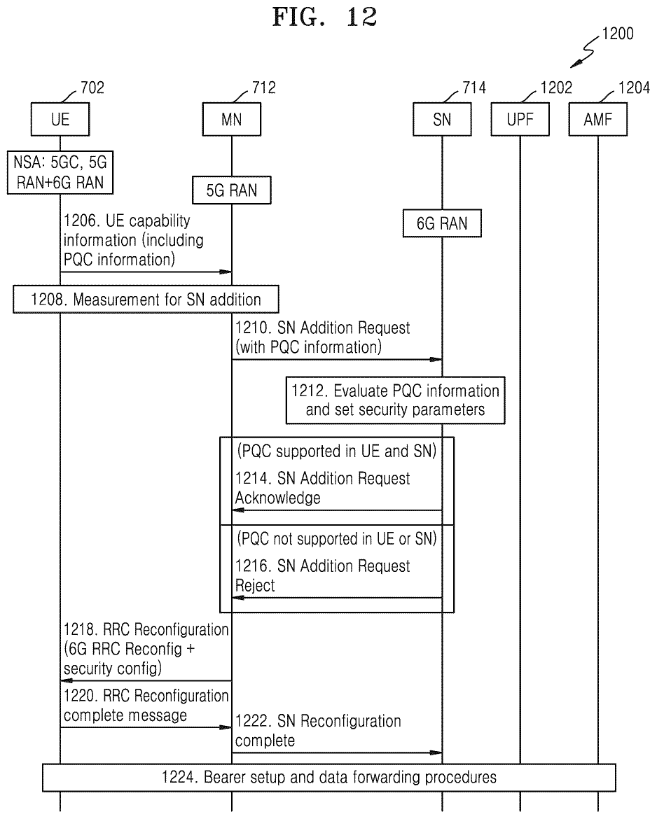

FIG. 12 illustrates a message sequence diagram 1200 indicating PQC related security aspects in SN addition procedure with 5GC (5G core network). For example, in security for 6G systems, new and improved algorithms such as PQC which are quantum computer resistant can be introduced and the message sequence diagram 1200 explores the method and procedure to handle SN addition based on the type of security algorithm supported in the UE 702 and the network 704. The message sequence diagram 1200 is a 6G SN addition procedure with MN 712 as 5G and 5GC network.

As indicated at step 1206, the UE capability Information including PQC information is sent from the UE 702 to the MN 712. A measurement report is sent from the UE 702 to the MN 712 for SN addition, as indicated at step 1208. The measurement report contains the measured signal levels from different cells by the UE 702. An SN addition request message is sent from the MN 712 to the SN 714 with the PQC information, as indicated at step 1210. The SN 714 evaluates the PQC information between the UE 702 and the SN 714 and sets the security parameters, as indicated at step 1212. If PQC is supported between the UE 702 and the SN 714, then an SN addition request acknowledge message is sent from the SN 714 to the MN 712, as indicated at step 1214. Else if PQC is not supported in the UE 702 or the SN 714, then an SN addition request reject message is sent from the SN 714 to the MN 712, as indicated at step 1216.

The MN 712 sends a RRC reconfiguration message (for example with 6G RRC reconfiguration and security configuration details) to the UE 702, on receiving the SN addition request acknowledge message, as indicated at step 1218. Further, the UE 702 sends an RRC reconfiguration complete message to the MN 712, as indicated at step 1220, after completion of reconfiguration based on the network data and one or more security parameters. The SN reconfiguration complete message is sent to the SN 714 from the MN 712, as indicated at step 1222. Further, bearers are set up between the UE 702, the MN 712, the SN 714, User Plane Function (UPF) 1202 and Access and Mobility Management Function (AMF) 1204, as indicated at step 1224, and data forwarding procedures are implemented.

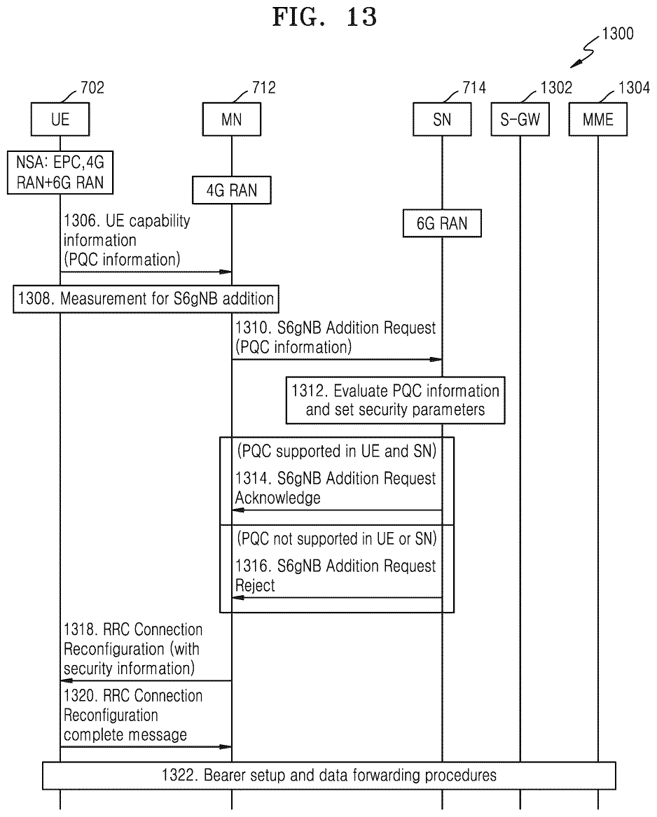

FIG. 13 illustrates a message sequence diagram 1300 indicating PQC related security aspects in SN addition procedure with Evolved Packet Core (EPC). For example, the message sequence diagram 1300 indicates 6G SN addition procedure with the MN 712 as 4G and EPC network. As indicated at step 1306, the UE capability information including PQC information is sent from the UE 702 to the MN 712. A measurement report is sent from the UE 702 to the MN 712, as indicated at step 1308, for S6gNB (6G next generation base station) addition. The MN 712 sends a S6gNB Addition Request message to the SN 714 with PQC information, as indicated at step 1310, based on the UE capability information and the measurement report.

The SN 714 evaluates the PQC information between the UE 702 and the SN 714 and sets or updates the security parameters, as indicated at step 1312. If PQC is supported between the UE 702 and the SN 714, then the SN 714 sends a S6gNB addition request acknowledge message to the MN 712, as indicated at step 1314. Else if PQC is not supported at the UE 702 or at the SN 714, then the SN 714 sends a S6gNB addition request reject message to the MN 712, as indicated at step 1316. Further, the MN 712 sends a RRC reconfiguration message with 6G RRC reconfiguration and security configuration details to the UE 702, as indicated at step 1318, on receiving the S6gNB addition request acknowledge message. The UE 702 sends RRC reconfiguration complete message to the MN 712, as indicated at step 1320, on completion of the RRC connection reconfiguration. Further, bearers are set up between the UE 702, the MN 712, the SN 714, S-GW 1302 and Mobility Management Entity (MME) 1304, as indicated at step 1322, and data forwarding procedures are implemented.

Table 1 indicates PQC related information within a SN addition request message. The SN addition request message includes the PQC support related aspect. The MN 712 prepares a SN/S6gNB addition request message including the UE capability and specifically security related elements to send to the SN 714. The UE capability information carries the PQC support capability information. The below SN addition request message is used when MN 712 is 5G and SN 714 is 6G RAT.

TABLE 1
S-NODE ADDITION REQUEST:
Direction: M-NG-RAN node -> S-6G RAN node

| IE/ | | | IE type | Semantics | | |
|---|---|---|---|---|---|---|
| Group | Pre- | | and | des- | Cri- | Assigned |
| Name | sence | Range | reference | cription | ticality | Criticality |
| PQC In- | M | | 9.2.3.X | | YES | reject |
| formation | | | | | | |

In the SN addition request message a new IE is introduced, for PQC information, as shown in Table 2. The details within PQC information, can include PQC support and PQC profiles. The PQC support can be categorized into three types as shown in the table, for example, PQC, legacy security method or both PQC and legacy security method. The PQC profiles or associated PQC parameters indicate if a relevant mechanism is supported at the UE side for at least one PQC support. For example, when PQC is supported, the related profile or algorithms are shared as P1, P2, P3, and so on. Based on the SN Addition Request message contents, related to PQC, the SN 714 needs to evaluate the UE 702 and SN PQC support and update the security parameters and determine if the UE is allowed to add the SN 714 or not.

TABLE 2

| IE/Group | | | IE type and | |
|---|---|---|---|---|
| Name | Presence | Range | reference | Semantics description |
| PQC | | | Legacy Only | PQC preferred supports both |
| Support | | | PQC Only | legacy and PQC securities |
| | | | PQC | while Legacy only and PQC |
| | | | Preferred | only support only as name |
| | | | | suggests. |
| PQC | | | 9.2.3.X.n | When PQC is supported, the |
| parameters | | | | related parameters or |
| | | | | algorithms are shared as in |
| | | | | 9.2.3.X.n. |

Table 3 indicates a S6gNB addition request message.

TABLE 3
S6gNB ADDITION REQUEST:
Direction: MeNB -> S6gNB

| IE/ | | | IE type | | | |
|---|---|---|---|---|---|---|
| Group | Pre- | | and | Semantics | Cri- | Assigned |
| Name | sence | Range | reference | description | ticality | Criticality |
| PQC In- | M | | 9.2.X | | YES | reject |
| formation | | | | | | |

The S6gNB addition request message is introduced with new IE, for PQC information as shown in Table 4. This 6gNB addition request message is used when the MN 712 is 4G and the SN 714 is 6G RAT.

TABLE 4

| IE/Group | | | IE type and | |
|---|---|---|---|---|
| Name | Presence | Range | reference | Semantics description |
| PQC | | | Legacy Only | PQC preferred supports |
| Support | | | PQC Only | both legacy and PQC |
| | | | PQC | securities while Legacy only |
| | | | Preferred | and PQC only support only |
| | | | | as name suggests. |
| PQC | | | 9.2.X.n | When PQC is supported, |
| Parameters | | | | the related parameters or |
| | | | | algorithms are shared as in |
| | | | | 9.2.X.n |

Table 5 indicates the PQC parameters that can be exchanged between network nodes/UE:

TABLE 5

| | | Key Length | |
|---|---|---|---|
| PQC | | (numerical | |
| Algorithm | Security Level | value) | Security parameters |
| Classic | (High, Medium, | n | This indicates further |
| McEliece | Low) | | list of unique security |
| Crystals- | (High, Medium, | n | parameters for each |
| Kyber | Low) | | algorithm required |
| NTRU | (High, Medium, | n | during exchange |
| | Low) | | |
| SABER | (High, Medium, | n | |
| | Low) | | |

PQC Algorithm: PQC algorithm is a list of all the supported algorithms. In the table 5, Classic McEliece, Crtystals-Kyber, NTRU and SABER are listed which are likely candidates for standardization.

Security level: Indicates if it has highest security level including quantum safe.

Key length: Indicates the length of the encryption key supported. Key length is a numerical value represented here as n. A range for this key can be specified in detail further when specifications are detailed.

Security parameters: This indicates further list of unique security parameters for each algorithm required during exchange

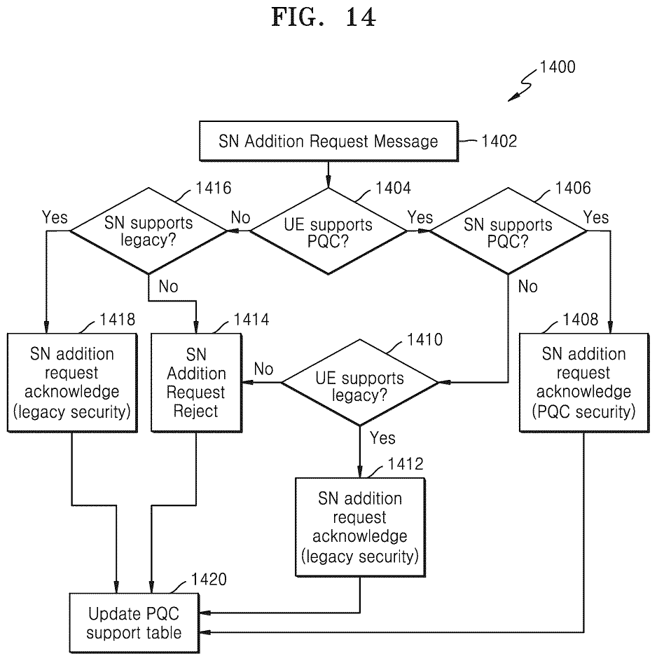

FIG. 14 illustrates a flowchart 1400 for evaluating PQC information at SN 714. Based on the SN addition request message contents received from the MN 712, related to PQC, the SN 714 needs to evaluate the UE 702 and SN 714 PQC support, update the security parameters, and determine if the UE 702 is allowed to add the SN 714 or not. The SN addition request message, as depicted in step 1402, carries the PQC information including the PQC support and related PQC profile or associated PQC parameters or algorithms supported at UE 702 side.

The SN 714 determines if the UE 702 supports PQC, as depicted in step 1404. If the UE 702 supports PQC, then the SN 714 checks if it supports PQC, as depicted in step 1406. If both the UE 702 and the SN 714 support PQC, then PQC is preferred and SN addition request acknowledge message is sent with PQC as preferred security method, as depicted in step 1408, from the SN 714 to the MN 712. If the UE 702 supports PQC and legacy security method, while the SN 714 does not support PQC, then the SN addition request acknowledge message is sent from the SN 714 to the MN 712 with the legacy security method, as depicted in step 1412. The verification whether the UE 702 supports legacy security method, is carried out in step 1410. If the UE 702 supports PQC only and the SN 714 supports legacy security method only, then the SN addition request is rejected due to mismatch in UE 702 and SN 714 capabilities, as depicted in step 1414.

If the UE 702 does not support PQC, as depicted in step 1404, and if the SN 714 supports the legacy security method, then the SN addition request is acknowledged with the legacy security method, as depicted in step 1418. The verification whether the SN 714 supports the legacy security method, is carried out in step 1416. If the UE 702 does not support PQC and the SN 714 does not support legacy security method (i.e., if the SN 714 supports PQC only, in that case, a mismatch occurs between the UE and the SN capabilities), then the SN addition request is rejected, as depicted in step 1414. In order to further optimize the process, a table can be maintained to update the PQC support and the PQC support table can be referred whenever the SN 714 addition or SN modification procedures are invoked, as depicted in step 1420.

Table 6 indicates an example PQC support table.

TABLE 6

| MN(NR/enb) | SN(6G) | PQC Support |
|---|---|---|
| Node UE XxAP | Node UE | Enumerated{Legacy only, |
| ID | XxAP ID | PQC supported, SN reject} |
| ID1 | ID1′ | Legacy only |
| ID2 | ID2′ | SN reject |
| ID3 | ID3′ | PQC supported |
| .. | | |
| IDn | IDn | PQC supported |

The PQC support table can be maintained at the MN 712 or SN 714 in order to optimize the SN addition considering PQC support. The Xx interface is assumed between the MN 712 and SN 714 for either of the deployment options of NSA with 6G RAT. The ID is an integer value whose range can be determined. The MN Node UE XxAP ID indicates the ID allocated at the MN 712 for the UE 702 using the Xx interface and the SN(6G) Node UE XxAP ID is the ID allocated at the SN-6G 714. The PQC support is the set of values that indicates for the given ID allocated by the MN 712 or SN 714 for UE 702 over Xx interface whether the overall result of the PQC support is legacy, PQC supported or SN reject.

When the PQC support table is updated with the values, the SN 714 need not evaluate the PQC information. The SN 714 can directly reference the support of PQC between the UE 702 and the SN 714 from the table and take decision accordingly. The evaluation of PQC support between the UE 702 and SN 714 is done at SN 714 and accordingly SN addition request acknowledge message or SN addition request reject message is sent by the SN 714. Alternatively, the PQC support table can also be maintained at MN 712 and the evaluation is then possible at MN 712.

In case of S6gNB/SN addition request message—measurements, when 6G RAT is introduced in SN 714, changes in the specifications are required to be made to certain messages and related IE. During SN addition, the SN addition request message is sent from the MN 712 to the SN 714. This SN addition request message carries relevant information for the SN 714 to prepare and service the UE 702. For example, CG-ConfigInfo is one such IE which carries relevant information and this needs to be updated to include 6G RAT related info.

Table 7 indicates an example SN addition request with MN as 5G and SN as 6G.

TABLE 7

| IE/Group | | | IE type and | Semantics | | Assigned |
|---|---|---|---|---|---|---|
| Name | Presence | Range | reference | description | Criticality | Criticality |
| M-NG-RAN | M | | OCTET | Includes the CG- | YES | reject |
| node to S- | | | STRING | ConfigInfo | | |
| 6G-RAN | | | | message as defined | | |
| node | | | | in subclause 11.2.2 | | |
| Container | | | | of TS 38.331 [10] | | |

Table 8 indicates an example S6gNB addition request with MN as 4G and SN as 6G.

TABLE 8

| IE/Group | | | IE type and | Semantics | | Assigned |
|---|---|---|---|---|---|---|
| Name | Presence | Range | reference | description | Criticality | Criticality |
| MeNB to | M | | OCTET | ncludes the CG- | YES | reject |
| S6gNB | | | STRING | ConfigInfo | | |
| Container | | | | message as defined | | |
| | | | | in TS 38.331 [31] | | |

As shown in table 7 and table 8, when S-Node addition request message or S6gNB addition request message is sent, then CG-ConfigInfo needs to be updated to include 6G RAT info related to measurements.

S6gNB/SN addition request message may include measurements and/or CG-ConfigInfo

This message is used to transfer the SCG radio configuration as generated by the SgNB or the SeNB. It can also be used by a Centralized Unit (CU) to request a Distributed Unit (DU) to perform certain actions; for example, to request the DU to perform a new lower layer configuration. CG-ConfigInfo may be represented as following Table 9.

TABLE 9

Direction: Secondary gNB or eNB or 6gNB to master gNB or eNB, alternatively CU
to DU.
-- ASN1START
-- TAG-CG-CONFIG-INFO-START
CG-ConfigInfo ::= SEQUENCE {
...
CG-ConfigInfo-IEs ::= SEQUENCE {
...
candidateCellInfoListMN MeasResultList2NR OPTIONAL,
candidateCellInfoListSN OCTET STRING (CONTAINING MeasResultList2NR)
OPTIONAL,
}
CG-ConfigInfo-v1560-IEs ::= SEQUENCE {
candidateCellInfoListMN-EUTRA OCTET STRING OPTIONAL,
candidateCellInfoListSN-EUTRA OCTET STRING OPTIONAL,
..
}
CG-ConfigInfo-vXX-IEs ::= SEQUENCE {
candidateCellInfoList6G-MN MeasResult6G OCTET STRING OPTIONAL,
candidateCellInfoList6G-SN OCTET STRING (CONTAINING MeasResult6G)
OPTIONAL,
..
}
-- TAG-CG-CONFIG-INFO-STOP
-- ASN1STOP

For example, IE is added within CG-ConfigInfo. CG-ConfigInfo-vXX-IEs where vXX shall denote the specification in which the changes are included. CandidateCellInfoList6GMN and CandidateCellInfoList6GSN are included within CGConfiglnfo-vXX-Ies which have MeasResult6G. The measurement results may be represented as following Table 10:

TABLE 10

MeasResult6G ::= SEQUENCE {
Frequency Frequencynumber-6G OPTIONAL,
refFreqReferenceSignal Frequencynumber-6G OPTIONAL,
measResultServingCell MeasResult6G OPTIONAL,
measResultNeighCellList6G MeasResultList6G OPTIONAL,
...
}

MeasResult6G, MeasResultList6G: Contains PCI/TRP ID, and associated measurement results.

Frequencynumber-6G—Indicates the associated arfcn for serving frequency.

In case of SN/SgNB addition request message—for UE capability transfer, according to the call flow for SN addition, the SN addition request message contains information required by the SN 714 to prepare a suitable SN cell for UE 702. The SN addition request message contains UE capability information. The UE capability information is sent in the CG-ConfigInfo IL represented as following Table 11. When 6G RAT is introduced, the IL is required to modify to include the RAT information and capability information of 6G RAT and following changes are required to address this.

TABLE 11

-- ASN1START
-- TAG-CG-CONFIG-INFO-START
CG-ConfigInfo-IEs ::= SEQUENCE {
ue-CapabilityInfo OCTET STRING (CONTAINING UE-Capa-
bilityRAT-ContainerList) OPTIONAL,-- Cond SN-AddMod
-- TAG-CG-CONFIG-INFO-STOP
-- ASN1STOP

For example, the ue-CapabilityInfo contains the IE UE-CapabilityRAT-ContainerList supported by the U 702. A gNB that retrieves MR-DC related capability containers ensures that the set of included MR-DC containers is consistent with respect to the feature set related information.

In case of S6gNB/SN addition request message—UE capability, table 12 indicates per MN RAT and SN RAT whether RAT capabilities are included or not in ue-CapabilityInfo. 6G RAT related info is required to add in UE capabilities for the cases where UU Radio Capability ID is not specified.

TABLE 12

| MN | SN | | E-UTRA | 6G | MR-DC |
|---|---|---|---|---|---|
| RAT | RAT | NR capabilities | capabilities | capabilities | capabilities |
| E-UTRA | NR | Need not be | Not included | NA | Need not be |
| | | included if the | | | included if the |
| | | UE Radio | | | UE Radio |
| | | Capability ID as | | | Capability ID as |
| | | specified in | | | specified in |
| | | 23.502 [43] is | | | 23.502 [43] is |
| | | used. Included | | | used. Included |
| | | otherwise | | | otherwise |
| NR | E-UTRA | Not included | Need not be | NA | Need not be |
| | | | included if the | | included if the |
| | | | UE Radio Ca- | | UE Radio |
| | | | pability ID as | | Capability ID as |
| | | | specified in | | specified in |
| | | | 23.502 [43] is | | 23.502 [43] is |
| | | | used. Included | | used. Included |
| | | | otherwise | | otherwise |
| NR | NR | Need not be | Not included | NA | Not included |
| | | included if the | | | |
| | | UE Radio | | | |
| | | Capability ID as | | | |
| | | specified in | | | |
| | | 23.502 [43] is | | | |
| | | used. Included | | | |
| | | otherwise | | | |
| EUTRA | 6G | NA | Not included | Included if | Included if UE |
| | | | | UE Radio | Radio |
| | | | | Capability | Capability ID is |
| | | | | ID is not | not used. |
| | | | | used. | |
| NR | 6G | Not included | NA | Included if | Included if UE |
| | | | | UE Radio | Radio |
| | | | | Capability | Capability ID is |
| | | | | ID is not | not used. |
| | | | | used. | |

Table 12 includes existing Evolved UMTS Terrestrial Radio Access (EUTRA) and New Radio (NR) RAT. But when 6G RAT is introduced, the table needs to include the direction for including the 6G capabilities for EUTRA-6G or NR-6G as MN-SN respectively. 6G capabilities and MR-DC capabilities column is added and within SN RAT 6G is added in the above table.

In case of S6gNB/SN addition request message-legacy security, a UE security capabilities IE defines the supported algorithms for encryption and integrity protection in the UE 702 and the S-NG-RAN node security key IE is used to apply security in the S-NG-RAN node as defined in TS 33.501. With the introduction of 6G RAT, the above IE needs to include 6G RAT info for securities and S-NG-RAN node security key as shown in below table 13 and table 14 that include 6G UE security capabilities IE and S-6G-RAN node security key IE/S6gNB security key IE. Table 13 indicates a SN addition request (5G-MN, 6G-SN).

TABLE 13
Direction: M-NG-RAN node -> S-6G-RAN node.

| IE/Group | | | IE type | Semantics | | Assigned |
|---|---|---|---|---|---|---|
| Name | Presence | Range | and reference | description | Criticality | Criticality |
| UE Context In- | | 0.1 | | | YES | reject |
| formation | | | | | | |
| >6G UE | O | | 9.2.3.X | | — | |
| Security Capa- | | | | | | |
| bilities | | | | | | |
| >S-6G-RAN | O | | 9.2.3.XX | | — | |
| node Security | | | | | | |
| Key | | | | | | |

Table 14 indicates a S6gNB addition request (4G-MN, 6G-SN).

TABLE 14
Direction: MeNB -> S6gNB.

| IE/Group | | | IE type | Semantics | | Assigned |
|---|---|---|---|---|---|---|
| Name | Presence | Range | and reference | description | Criticality | Criticality |
| UE Context In- | | 0 . . . 1 | | | YES | reject |
| formation | | | | | | |
| >6G UE | O | | 9.2.X | | — | |
| Security Capa- | | | | | | |
| bilities | | | | | | |
| >S6gNB | O | | 9.2.XX | | — | |
| Security Key | | | | | | |

S-6G-RAN node security key, S6gNB security key are the keys provided by the MN.

In case of S6gNB/SN addition request message—legacy security, the 6G UE security capabilities IE defines the supported algorithms for encryption and integrity protection in the UE 702. Table 15 indicates the 6G encryption algorithms and 6G integrity protection algorithms.

TABLE 15

| IE/Group | | | IE Type and | Semantics |
|---|---|---|---|---|
| Name | Presence | Range | Reference | Description |
| 6G Encryption | M | | BIT STRING (6G en- | Each position |
| Algorithms | | | cryption algorithm1, | in |
| | | | 6G encryption | the bitmap |
| | | | algorithm2, 6G en- | represents an |
| | | | cryption algorithm3, | encryption |
| | | | etc . . . ) | algorithm |
| 6G Integrity | M | | BIT STRING (6G | Each position |
| Protection | | | Integrity algorithm1, | in |
| Algorithms | | | 6G Integrity | the bitmap |
| | | | algorithm2, 6G | represents an |
| | | | Integrity | encryption |
| | | | algorithm3 . . . etc.) | algorithm |

In an embodiment herein, the SN addition request acknowledge message contains CG-Config which contains RadioBearerConfig. RadioBearerConfig is defined in TS 38.331 and contains the SecurityAlgorithmConfig for the corresponding bearer. In order to reflect the PQC support, PQC algorithms and PQC support at network side is indicated in the RRC reconfiguration message. Table 16 indicates SN addition request acknowledge message.

TABLE 16
Direction: S6gNB -> MgNB.
SN addition request acknowledge contains the following IE.

| IE/Group | | | IE type | Semantics | | Assigned |
|---|---|---|---|---|---|---|
| Name | Presence | Range | and reference | description | Criticality | Criticality |
| S-NG-RAN | M | | OCTET | Includes the CG- | YES | reject |
| node to M- | | | STRING | Config message or | | |
| NG-RAN | | | | the CG- | | |
| node | | | | CandidateList | | |
| Container | | | | message as defined | | |
| | | | | in subclause 11.2.2 | | |
| | | | | of TS 3x.331 [10]. | | |

Table 17 indicates S6gNB addition request acknowledge message.

TABLE 17
Direction: S6gNB->MeNB.

| IE/Group | | | IE type | Semantics | | Assigned |
|---|---|---|---|---|---|---|
| Name | Presence | Range | and reference | description | Criticality | Criticality |
| SgNB to | M | | OCTET | Includes the | YES | reject |
| MeNB | | | STRING | CG-Config | | |
| Container | | | | message or the | | |
| | | | | CG-CandidateL | | |
| | | | | ist message, as | | |
| | | | | defined in TS | | |
| | | | | 3x.331[31] | | |

For example, when 6G RAT is introduced in SN, changes in the specifications are required to be made to certain messages and related IE. During SN addition, according to known procedures, SN addition request acknowledge message is sent from SN 714 to MN 712. This message carries relevant information to inform MN 712 about SN aspects. CG-Config is one such IE which carries relevant information and this needs to be updated to include 6G RAT related info.

In case of SN addition request acknowledge, CG-Config may be represented as following Table 18:

TABLE 18

-- ASN1START
-- TAG-CG-CONFIG-START
CG-Config ::= SEQUENCE {
..
CG-Config-IEs ::= SEQUENCE {
scg-CellGroupConfig OCTET STRING (CONTAINING RRCReconfiguration)
OPTIONAL,
scg-RB-Config OCTET STRING (CONTAINING RadioBearerConfig) OPTIONAL,
candidateCellInfoListSN OCTET STRING (CONTAINING MeasResultList2NR)
OPTIONAL,
...
}
CG-Config-v1560-IEs ::= SEQUENCE {
scg-CellGroupConfigEUTRA OCTET STRING OPTIONAL,
candidateCellInfoListSN-EUTRA OCTET STRING OPTIONAL,
CG-Config-v1590-IEs ::= SEQUENCE {
scellFrequenciesSN-NR SEQUENCE (SIZE (1.. maxNrofServingCells-1)) OF
ARFCN-ValueNR OPTIONAL,
scellFrequenciesSN-EUTRA SEQUENCE (SIZE (1.. maxNrofServingCells-1)) OF
ARFCN-ValueEUTRA OPTIONAL,
nonCriticalExtension CG-Config-v1610-IEs OPTIONAL
}
CG-Config-vXX-IEs ::= SEQUENCE {
scg-CellGroupConfig6G OCTET STRING (CONTAINING RRCReconfiguration6G)
OPTIONAL,
candidateCellInfoListSN-6G OCTET STRING OPTIONAL,
scellFrequenciesSN-6G SEQUENCE (SIZE (1.. maxNrofServingCells-1)) OF
ARFCN-Value6G OPTIONAL
}
}
-- TAG-CG-CONFIG-STOP
-- ASN1STOP

For example, IE is added within CG-Config. CG-Config-vXX-IEs where vXX shall denote the specification in which the changes can be included. scg-CellGroupConfig6G, candidateCellInfoListSN-6G, and scellFrequenciesSN-6G are included within CG-Config-vXX-Ies.

Scg-CellGroupConfig6G IE—This carries the RRC reconfiguration info for the 6G SN.

CandidateCellInfoListSN-6G—contains information regarding cells that the source secondary node suggests the target secondary node to consider configuring.

ScellFrequenciesSN-6G—Indicates frequency of all Secondary cells (Scells) with sync signals configured.

In case of SN addition request acknowledge—IE, for example in RRC reconfiguration, 6G RAT related information needs to be added to CG-Config from SN (6G RAT) to MN (NR or Long Term Evolution (LTE)) as applicable. scg-CellGroupConfig, scg-CellGroupConfigEUTRA—carry the RRC reconfiguration information. Similarly scg-CellGroupConfig6G is required to carry RRC reconfiguration message. Table 19 indicates RRC Reconfiguration.

TABLE 19

| RRC Reconfig-NR | RRC Reconfig-EUTRA | RRC Reconfig-6G |
|---|---|---|
| scg-CellGroupConfig | scg- | scg- |
| OCTET STRING | CellGroupConfigEUTR | CellGroupConfig6G |
| (CONTAINING | A OCTET STRING | OCTET STRING |
| RRCReconfiguration) | OPTIONAL, | OPTIONAL |
| OPTIONAL, | | |

For example, candidate Cell Info List SN contains information regarding cells that the source secondary node suggests the target secondary node to consider configuring. Similarly 6G RAT related IE, Candidate Cell Info List-6G is needed for 6G candidate cells for target SN to configure. Table 20 indicates candidate Cell Info List SN.

TABLE 20

| Candidate Cell info | | Candidate Cell Info |
|---|---|---|
| list SN-NR | Candidate Cell info List-EUTRA | List-6G |
| candidateCellInfoListSN | candidateCellInfoListSN-E | candidateCellInfoListSN-6G |
| OCTET STRING | UTRA OCTET STRING | OCTET-STRING |
| (CONTAINING | OPTIONAL, | OPTIONAL, |
| MeasResultList2NR) | | |
| OPTIONAL, | | |

For example, frequencies configured in SN such as scellFrequenciesSN-EUTRA and scellFrequenciesSN-NR indicate frequency of all SCells with Synchronization Signal Block (SSB) configured in SCG. The field scellFrequenciesSN-EUTRA is used in NEDC; the field scellFrequenciesSN-NR is used in (NG) E-UTRAN NR Dual Connectivity (ENDC) and New Radio Dual Connectivity (NR-DC). In (NG) ENDC, the field is optionally provided to the MN. scellFrequenciesSN-NR indicates absoluteFrequencySSB. Similarly, 6G SN frequencies are required to be added. Hence, scellFrequenciesSN-6G is added which contains the frequency number of the 6G. Table 21 indicates scellFrequenciesSN.

TABLE 21

| scellFrequenciesSN-NR | scellFrequenciesSN-EUTRA | scellFrequenciesSN-6G |
|---|---|---|
| scellFrequenciesSN-NR | scellFrequenciesSN-EUTR | scellFrequenciesSN-6G |
| SEQUENCE (SIZE (1.. | A SEQUENCE (SIZE (1.. | SEQUENCE (SIZE (1.. |
| maxNrofServingCells-1)) | maxNrofServingCells-1)) | max6GofServingCells-1)) |
| OF ARFCN-ValueNR | OF ARFCN-ValueEUTRA | OF ARFCN-Value6G |

In case of SN addition request acknowledge for PQC, RadioBearerConfig may be represented as following Table 22.

TABLE 22

-- ASN1START
-- TAG-RADIOBEARERCONFIG-START
RadioBearerConfig ::= SEQUENCE {
SecurityConfig ::= SEQUENCE {
securityAlgorithmConfig Security AlgorithmConfig OPTIONAL, -- Cond
RBTermChange1
keyToUse ENUMERATED{master, secondary} OPTIONAL, -- Cond
RBTermChange
...
USEPQC ENUMERATED{TRUE} OPTIONAL
}
-- TAG-RADIOBEARERCONFIG-STOP
-- ASN1STOP

The IE RadioBearerConfig is used to add, modify and release signaling, Multicast Radio Bearers (MRBs) and/or data radio bearers. USE PQC IE is additionally defined within RadioBearerConfig to be set as TRUE. If USE PQC IE is absent, it indicates that the PQC is not supported and UE 702 can use the legacy algorithms.

Furthermore, UE procedures are defined to handle the PQC support in TS 3x.331. The added aspect for AS security key updates may be represented as following Table 23.

TABLE 23
5.3.5.7 AS Security Key Update
If the UE 702 is connected to 6GRAT with 5GC
if RadioBearerConfig contains USEPQC set to TRUE
Perform the PQC key generation and related procedures
Use the PQC algorithm from securityAlgorithmConfig containing
PQCAlgorithmConfig

In the SecurityAlgorithmConfig, additional PQC algorithms can be added to indicate the supported set of algorithms within PQC such as P1, P2, P3, and so on. SecurityAlgorithmConfig may be represented as following Table 24:

TABLE 24

-- ASN1START
-- TAG-SECURITYALGORITHMCONFIG-START
SecurityAlgorithmConfig ::= SEQUENCE {
cipheringAlgorithm CipheringAlgorithm,
integrityProtAlgorithm IntegrityProtAlgorithm OPTIONAL, -- Need R
...
}
IntegrityProtAlgorithm ::= ENUMERATED {
nia0, nia1, nia2, nia3, spare4, spare3,
spare2, spare1, ...}
CipheringAlgorithm ::= ENUMERATED {
nea0, neal, nea2, nea3, spare4, spare3,
spare2, spare1, ...}
PQCAlgorithmConfig :: = SEQUENCE {
PQC Algorithm { P1, P2 , ...}
-- TAG-SECURITYALGORITHMCONFIG-STOP
-- ASN1STOP

In case of SN addition procedure at UE side with NR Master Cell Group (MCG), specification 38.331 describes reception of RRC reconfiguration message for SN addition. The RRC reconfiguration message and procedure needs to handle 6G SCG info. 6G-SCG info needs to be added to handle the RRC configuration info for 6G SN.

### 5.3.5.3 Reception of an RRCReconfiguration by the UE

The UE shall perform the following actions upon reception of the RRCReconfiguration, or upon execution of the conditional reconfiguration (Conditional Handover (CHO), CPA or Cooperative Hierarchical Caching (CPC)):
1> if the RRCReconfiguration includes the mrdc-SecondaryCellGroupConfig:
*2> if the mrdc-SecondaryCellGroupConfig is set to setup:
**3> if the mrdc-SecondaryCellGroupConfig includes mrdc-ReleaseAndAdd:
***4> perform MR-DC release as specified in clause 5.3.5.10;
**3> if the received mrdc-SecondaryCellGroup is set to nr-SCG:
***4> perform the RRC reconfiguration according to 5.3.5.3 for the RRCReconfiguration message included in nr-SCG;
**3> if the received mrdc-SecondaryCellGroup is set to eutra-SCG:
***4> perform the RRC connection reconfiguration as specified in TS 36.331 [10], clause 5.3.5.3 for the RRCConnectionReconfiguration message included in eutra-SCG;
**3> if the received mrdc-SecondaryCellGroup is set to 6G-SCG:
***4> perform the RRC connection reconfiguration. RRC spec for 6G shall describe the procedure to configure the contents in this message.

Mrdc-SecondaryCellGroup may be represented as following Table 25:

TABLE 25

-- ASN1START
-- TAG-RRCRECONFIGURATION-START
MRDC-SecondaryCellGroupConfig ::= SEQUENCE {
mrdc-ReleaseAndAdd ENUMERATED {true} OPTIONAL, -- Need N
mrdc-SecondaryCellGroup CHOICE {
nr-SCG OCTET STRING (CONTAINING RRCReconfiguration),
eutra-SCG OCTET STRING
6G-SCG OCTET STRING
}
}
-- TAG-RRCRECONFIGURATION-STOP
-- ASN1STOP

6G SCG is an OCTET string that contains the RRC Reconfiguration message of the 6G SN.

In case of SN addition procedure at UE side with LTE MCG when 6G RAT is added, there is a need to add procedure and IE to define 6G-SecondaryCellGroupConfig. Reception of an RRCConnectionReconfiguration not including the mobilityControlInfo by the UE is as given as follows:
1> if the UE is in EN-6GDC and;
1> if the RRCConnectionReconfiguration does not include the 6G-SecondaryCellGroupConfig:
*2> if the RRCConnectionReconfiguration includes the scg-State:
**3> perform SCG deactivation as specified in 6G RRC spec;
*2> else:
**3> perform SCG activation without SN message as specified in 6G RRC spec;
1> if the received RRCConnectionReconfiguration includes the 6G-Config and it is set to release: or
1> if the received RRCConnectionReconfiguration includes EN-6GDC-ReleaseAndAdd and it is set to TRUE:
*2> perform MR-DC release as specified in 6G RRC spec;
1> if the received RRCConnectionReconfiguration includes the 6G-SecondaryCellGroupConfig:
*2> perform NR RRC Reconfiguration as specified in 6G RRC spec;
6G-SecondaryCellGroupConfig includes 6G RRCReconfiguration message as specified in 6G RRC spec. 6G-SecondaryCellGroupConfig may be represented as following Table 26:

TABLE 26

RRCConnectionReconfiguration-IEs ::= SEQUENCE {
6G-Config CHOICE {
release NULL,
setup SEQUENCE {
EN-6GDC -Release AndAdd BOOLEAN,
6G-SecondaryCellGroupConfig-rXX OCTET STRING OPTIONAL, -- Need ON
}
}

In case of SN addition request reject with PQC support, if there is a mismatch between the UE 702 and SN 714 capabilities related to PQC support, then SN addition request reject procedure is initiated. The following changes are identified to handle the same. Table 27 indicates SN addition request reject.

TABLE 27
S-NODE ADDITION REQUEST REJECT

| IE/ | | | IE type | Semantics | | Assigned |
|---|---|---|---|---|---|---|
| Group | | | and | descrip- | Criti- | Criti- |
| Name | Presence | Range | reference | tion | cality | cality |
| Cause | M | | 9.2.3.2 | | YES | ignore |

The purpose of the Cause IE is to indicate the reason for a particular event for the XxAP protocol. Cause with PQC not supported can be added to radio network layer causes to indicate the reason of reject when PQC is not supported. Table 28 indicates cause with PQC not supported.

TABLE 28

| | | | | Semantics |
|---|---|---|---|---|
| IE/Group Name | Presence | Range | IE Type and Reference | Description |
| CHOICE Cause | M | | | |
| Group | | | | |
| >Radio Network | | | | |
| Layer | | | | |
| >> Radio | | | ENUMERATED{PQC | |
| Network Layer | | | not supported} | |
| Cause | | | | |

In an embodiment herein, in case of Conditional PSCell Addition (CPA), when 6G RAT is added and PQC security aspects are considered, the SN addition request acknowledge message is as shown in table 29

TABLE 29

| | | | | |
|---|---|---|---|---|
| Conditional PSCell | O | | | YES |
| Addition Information | | | | |
| Acknowledge | | | | |
| >Candidate PSCell List | | 1 | | — |
| >>Candidate PSCell | | 1.. | | — |
| Item | | <maxnoofPSCell | | |
| | | Candidate> | | |
| >>>PSCell ID | M | | NR CGI 9.2.2.7 | — |
| | | | 6G CGI 9.x | |

Table 30 shows S6gNB addition request acknowledge message for CPA, when 6G RAT is added and PQC security aspects are considered.

TABLE 30

| Conditional | | | | | |
|---|---|---|---|---|---|
| PSCell | | | | | |
| Addition | | | | | |
| Information | | | | | |
| Acknowledge | O | | | YES | ignore |
| >Candidate | | 1 | | — | |
| PSCell List | | | | | |
| >>Candidate | | 1 . . . | | — | |
| PSCell Item | | <maxnoofPS | | | |
| | | CellCandi- | | | |
| | | date> | | | |
| >>>PSCell | M | | NR CGI | — | |
| ID | | | 9.2.111 | | |
| | | | 6G CGI | | |
| | | | 9.x | | |

6G Cell Global ID (CGI) information needs to be defined and utilized in case of CPA. Table 31 indicates a 6G CGI.

TABLE 31

| | | | IE type and | Semantics |
|---|---|---|---|---|
| IE/Group Name | Presence | Range | reference | description |
| PLMN Identity | M | | 9.2.2.4 | |
| 6G Cell Identity | M | | BIT STRING | |
| | | | (SIZE(36)) | |

In SN addition acknowledge message, NR CGI info is present. However, 6G CGI info is to be added to handle the 6G RAT impacts. 6G CGI info contains the 6G Cell identity and Public Land Mobile Network (PLMN) identity.

In case of CPA procedure, TS 36.331 captures the reportconfiginterRAT. 6G RAT needs to be added here as following Table 32.

TABLE 32
[[condReconfigurationTriggerNR-r17
CondReconfigurationTriggerNR-r17
OPTIONAL -- Need ON
]]
[[condReconfigurationTrigger6G
CondReconfigurationTrigger6G OPTIONAL --
Need ON
]]
}
CondReconfigurationTrigger6G ::= SEQUENCE {
condEventId-r ** CHOICE {
condEventB 1-6G-r**
SEQUENCE {
b1-Threshold6G-r ** ThresholdNR-r15,
hysteresis-r ** Hysteresis,
timeToTrigger-r ** TimeToTrigger
},
. . .
}

TS 38.331, ReportConfigInterRAT needs to add 6G RAT related information for CPA procedures, as following Table 33.

TABLE 33
[[condReconfigTrigger6G CondReconfig
Trigger6G OPTIONAL -- Need
ON
]]
CondReconfigTrigger6G ::= SEQUENCE {
condEventId-r**
CHOICE {
condEventB1-6G-r ** SEQUENCE {
b1-Threshold6G-r ** ThresholdNR-r15,
hysteresis-r ** Hysteresis,
timeToTrigger-r ** TimeToTrigger
},

The above configuration captures the conditional event related parameters that are needed to trigger a CPA procedure at UE side.

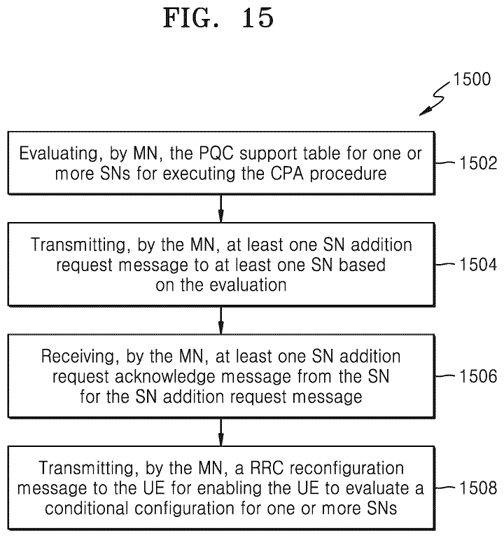

FIG. 15 illustrates a method 1500 of CPA procedure with PQC support table by the MN 712. The method 1500 comprises evaluating, by the MN 712, the PQC support table for one or more SNs 714, as depicted in step 1502, for executing the CPA procedure. The method 1500 comprises transmitting, by the MN 712, at least one SN addition request message to at least one SN 714 based on the evaluation, as depicted in step 1504.

The method 1500 comprises receiving, by the MN 712, at least one SN addition request acknowledge message from the SN 714 for the SN addition request message, as depicted in step 1506. The method 1500 further comprises transmitting, by the MN 712, a RRC reconfiguration message including information of one or more SNs 714 to the UE 702 for the received SN addition request acknowledge message, as depicted in step 1508, for enabling the UE 702 to evaluate a conditional configuration for one or more SNs 714. The conditional configuration comprises one or more conditional event related parameters of the RAT of the network that are needed to trigger the CPA procedure at UE side.

The various actions in method 1500 may be performed in the order presented, in a different order or simultaneously. Further, in some embodiments, some actions listed in FIG. 15 may be omitted.

In CPA procedure, multiple SNs 714 are prepared by the UE 702 and the UE 702 can chose to add the SN 714 which meets the conditions specified in a conditional configuration. With the PQC support, the CPA procedure can be further enhanced. Two solutions are proposed for the CPA procedure. One is PQC support table based CPA at MN 712, and the other is UE based selection for CPA.

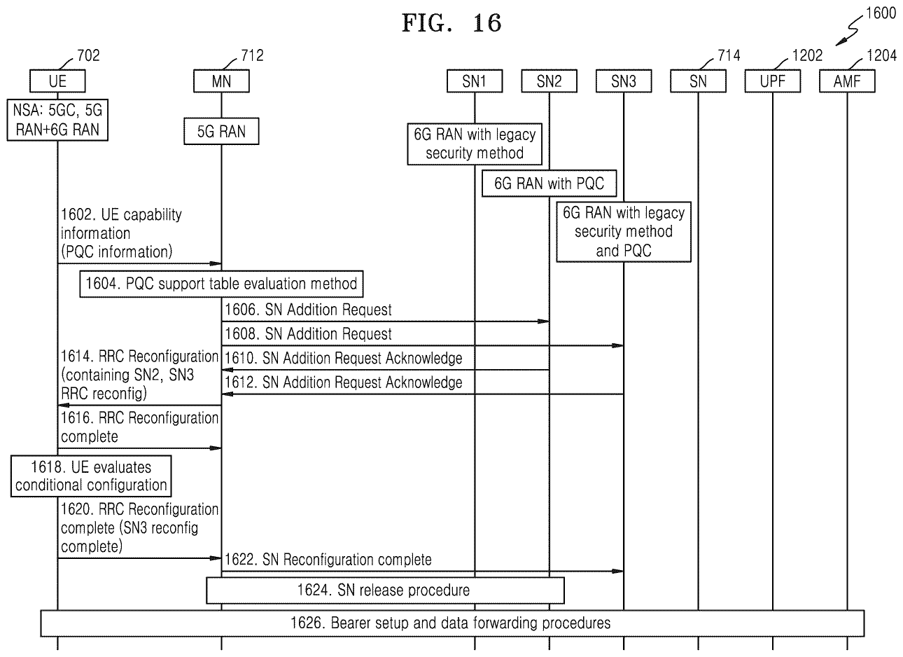

FIG. 16 illustrates a message sequence diagram 1600 indicating a CPA procedure using the PQC support table. As depicted in step 1602, the UE 702 sends UE capability information with PQC information to the MN 712. The MN 712 evaluates the PQC support table for one or more SNs 714, for executing the CPA procedure, as depicted in step 1604. The MN 712 evaluates that SN1 supports only legacy security method while SN2 supports PQC only and SN3 supports PQC and legacy algorithms. The MN 712 determines that SN2 and SN3 support PQC based on the evaluation and thereafter prepares SN2 and SN3 with SN addition requests as depicted in steps 1606 and 1608.

Later, the MN 712 receives the SN addition request acknowledge messages from the SN2 and SN3, as depicted in steps 1610 and 1612, for the SN addition requests. The MN 712 transmits a RRC reconfiguration message including information of the SN2 and SN3 to the UE 702, as depicted in step 1614. The UE 702 reconfigures with the information of the SN2 and SN3 and transmits a RRC reconfiguration complete message to the MN 712, as depicted in step 1616.

The UE 702 evaluates one or more security parameters of the SN1 and SN2 to match with PQC capability of the UE 702. The UE 702 determines if evaluation of the conditional configuration is required for the respective SN1 and SN2. The UE 702 evaluates a conditional configuration for the SN1 and SN2, if the conditional configuration is required, as depicted in step 1618. The UE 702 connects to a desired SN i.e., SN3, as the evaluated conditions are met with SN3. The UE 702 sends a reconfiguration complete message with SN3 to the MN 712, as depicted in step 1620. The MN 712 sends a SN reconfiguration complete message to the SN3, as depicted in step 1622. Further, the MN 712 performs a SN release procedure with the SN1 and SN2, as depicted in step 1624. Later, bearers are set up between the UE 702, the MN 712, SN1, SN2, SN3, SN 714, UPF 1202 and AMF 1204, as indicated at step 1626, and data forwarding procedures are implemented.

Table 34 below indicates the PQC support table that is defined and maintained at MN 712 which keeps information about all associated SNs 714 whether the SNs 714 support PQC or not. Table 34 provides a list of security capability of SN 714 maintained at MN 712.

TABLE 34

| SN1 | SN2 | .. | SNx |
|---|---|---|---|
| Legacy | PQC | | PQC, Legacy |

In case of UE based selection for CPA, in order for the UE 702 to determine PQC support and select the corresponding SN, MN 712/SN 714 needs to inform the UE 702 about PQC capability in RRC reconfiguration. The PQC capability in RRC reconfiguration may be transmitted using the format represented as following Table 35.

TABLE 35
ReportConfigInterRAT
-- ASNISTART
-- TAG-REPORTCONFIGINTERRAT-START
ReportConfigInterRAT ::= SEQUENCE {
. . .
SecurityType ENUMERATED {PQC, Legacy,
PQC + Legacy } }
-- TAG-REPORTCONFIGINTERRAT-STOP
-- ASNISTOP

Similar changes can be added in 36.331 for ReportConfigInterRAT. The UE 702 can evaluate security type to match with PQC capability and determine if conditional evaluation needs to be done or not for the respective SN 714.

For example, if UE 702 supports PQC: for the given meas ID, the reporConfigInterRAT, if security type also supports PQC, then choose the SN 714 for conditional configuration evaluation.

If UE 702 supports Legacy only: for the given meas ID, reportConfigInterRAT, if security type also supports legacy then choose the SN 714 for conditional configuration evaluation

If UE 702 and given security type does not match, do not choose the SN 714 for conditional configuration evaluation.

Therefore, the UE 702 can determine if conditional evaluation needs to be done for the configured cells based on the security type.

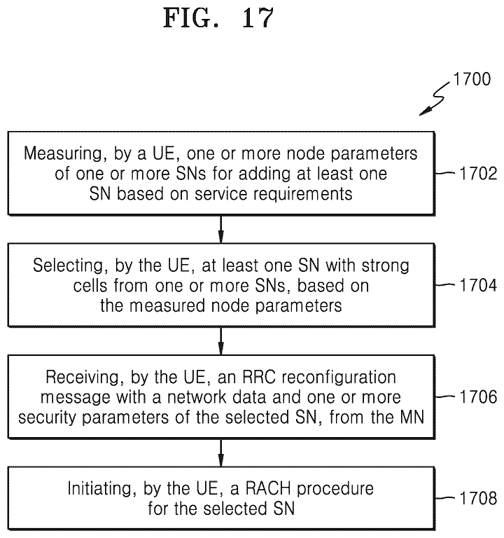

FIG. 17 illustrates a method 1700 of UE initiated SN addition procedure. The method 1700 comprises measuring, by the UE 702, one or more node parameters of one or more SNs 714 for adding at least one SN based on service requirements, as depicted in step 1702. The method 1700 comprises selecting, by the UE 702, the SN 714 with strong cells from one or more SNs 714, based on the measured node parameters, as depicted in step 1704. Thereafter, the MN 712, with its MN ID indicates to the selected SN ID, that the UE 702 has requested to add the SN 714. The method 1700 comprises receiving, by the UE 702, an RRC reconfiguration message with a network data and one or more security parameters of the selected SN 714, from the MN 712, as depicted in step 1706. The method 1700 comprises initiating, by the UE 702, a RACH procedure for the selected SN 714, as depicted in step 1708. The SN 714 sends an indication to the MN 712 related to the MN ID that the UE 702 has requested to add the SN 714.

The various actions in method 1700 may be performed in the order presented, in a different order or simultaneously. Further, in some embodiments, some actions listed in FIG. 17 may be omitted.

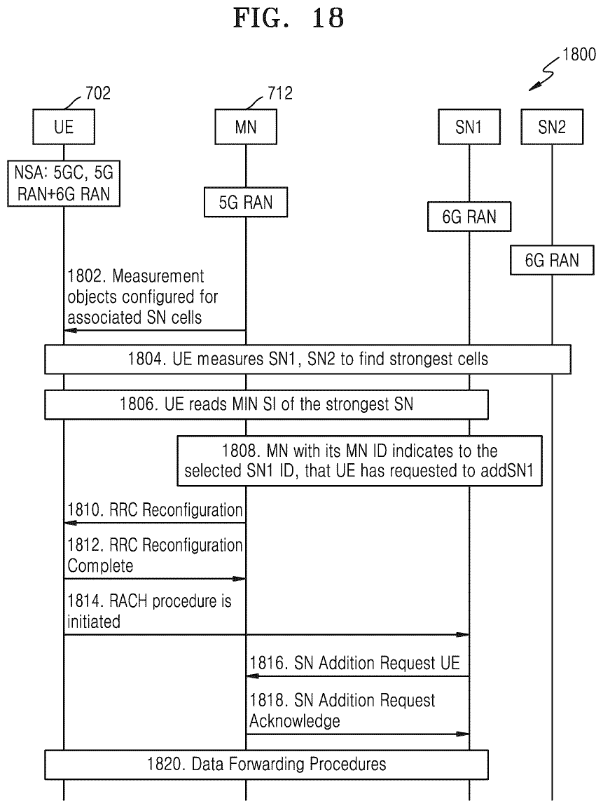

FIG. 18 illustrates a message sequence diagram 1800 indicating a UE initiated SN addition procedure. As depicted in step 1802, the MN 712 can configure all measurement objects in the UE 702, for associated SN cells. The UE 702 is aware of its service or data requirements. Based on the UE requirements, the UE 702 can measure one or more node parameters (TRP/Cell id) of SN1 and SN2 to find strongest cells, as depicted in step 1804.

The UE 702 reads Minimum System Information (MIN SI) block of the strongest SN i.e., SN1, as depicted in step 1806, based on the node parameters. The MIN SI block comprises information for RACH procedure. The MN 712, with its MN ID indicates to the selected SN1 ID, that the UE 702 has requested to add the selected SN1, as depicted in step 1808. The UE 702 receives a RRC reconfiguration message with a network data and one or more security parameters of the SN1, from the MN 712, as depicted in step 1810. Later, the UE 702 sends a RRC reconfiguration complete message to the MN 712, as depicted in step 1812, after reconfiguration.

The UE 702 initiates a RACH procedure in SN1, as depicted in step 1814. The SN1 sends an indication to the MN 712 related to the MN ID that the UE 702 has requested to add the SN1 using SN addition request UE message, as depicted in step 1816. The MN 712 transmits a SN addition request acknowledge message to the SN1, as depicted in step 1818, based on the received SN addition request UE message. Thereafter, data forwarding procedures can be performed between the UE 702, the MN 712, and SN1, as depicted in step 1820.

PQC related Security Aspects in SN Modification:

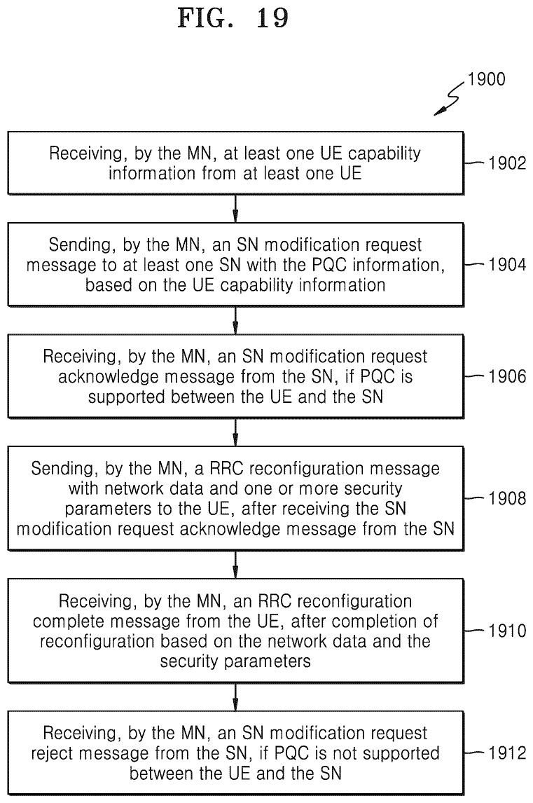

FIG. 19 illustrates a method 1900 for handling SN modification in MR-DC. The method 1900 comprises receiving, by the MN 712, at least one UE capability information from at least one UE 702, as depicted in step 1902. The UE capability information comprises PQC information. The method 1900 comprises sending, by the MN 712, an SN modification request message to at least one SN 714 with the PQC information, based on the UE capability information, as depicted in step 1904. The SN modification request message comprises information of one or more candidate cells. The information of the candidate cells comprises measurement results of one or more node parameters of one or more SNs for choosing and configuring the SN (714). The SN modification request message comprises the UE capability information and a UE capability co-ordination result. The UE capability information comprises a RAT information including 6G RAT. The method 1900 comprises receiving, by the MN 712, an SN modification request acknowledge message from the SN 714, if PQC is supported between the UE 702 and the SN 714, as depicted in step 1906. The SN modification request acknowledge message comprises at least one of an RRC reconfiguration information related to the SN (714) of the network (704), and a global cell identity of the SN (714) for executing the CPA procedure by the UE (702).

The method 1900 comprises sending, by the MN 712, the RRC reconfiguration message with a network data and one or more security parameters to the UE 702, after receiving the SN modification request acknowledge message from the SN 714, as depicted in step 1908. The method 1900 comprises receiving, by the MN 712, an RRC reconfiguration complete message from the UE 702, after completion of reconfiguration based on the network data and the security parameters, as depicted in step 1910. Further, the method 1900 comprises receiving, by the MN 712, an SN modification request reject message from the SN 714, if PQC is not supported between the UE 702 and the SN 714, as depicted in step 1912.

The various actions in method 1900 may be performed in the order presented, in a different order or simultaneously. Further, in some embodiments, some actions listed in FIG. 19 may be omitted.

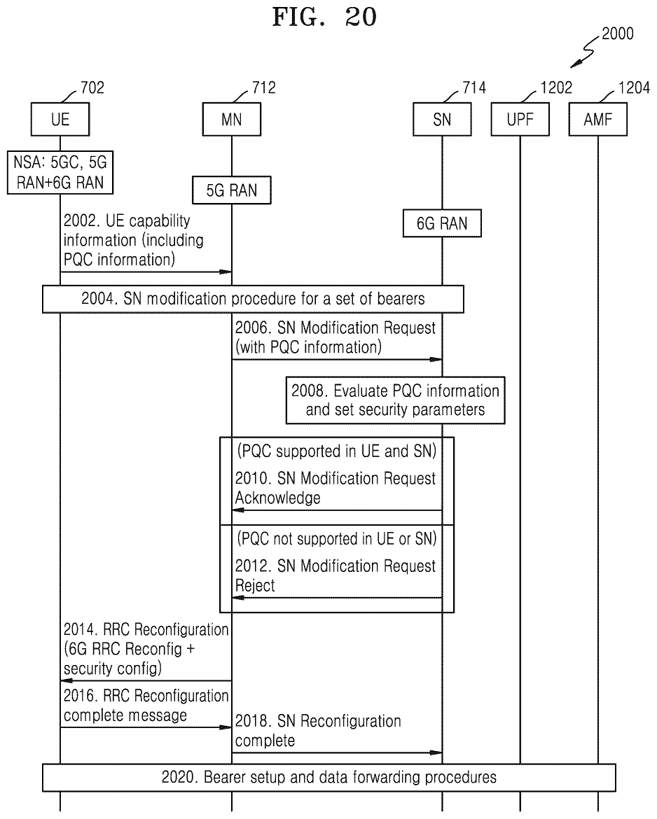

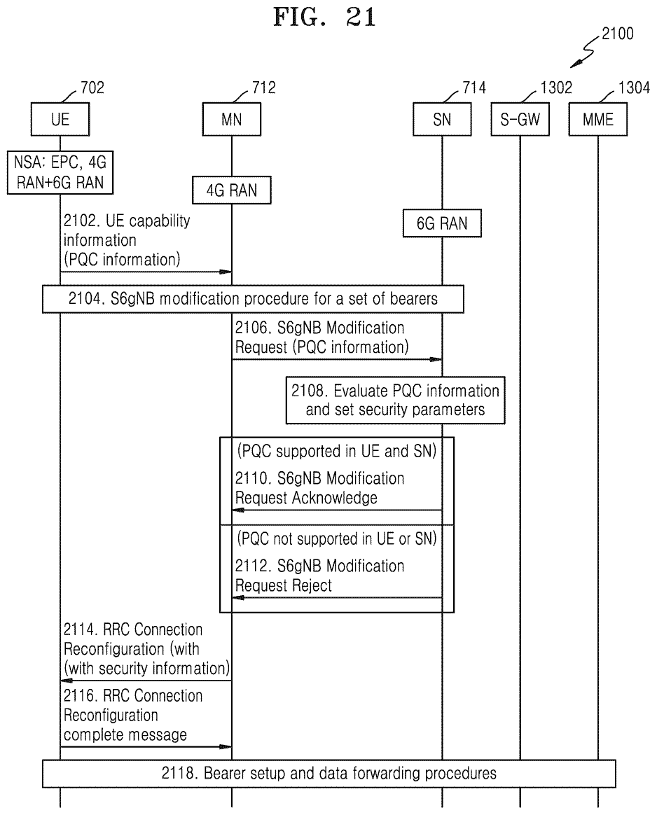

In the SN modification procedures as shown in FIG. 20 and FIG. 21, a SN modification request message or a S6gNB modification request message carry security information among multiple things exchanged between the MN 712 and SN 714 like below:

When PQC related security aspects are introduced, along with 6G RAT, it is necessary to define mechanisms for handling the PQC related capability aspects in NSA deployments for SN modification aspects.

FIG. 20 illustrates a message sequence diagram 2000 indicating PQC related security aspects in SN modification procedure for deployment option of NSA with 5GC (5G core network). For example, in security for 6G systems, new and improved algorithms such as PQC which are quantum computer resistant can be introduced and the message sequence diagram 2000 explores the method and procedure to handle SN modification based on the type of security algorithm supported in the UE 702 and the network 704. The message sequence diagram 2000 is a 6G SN modification procedure with MN 712 as 5G and 5GC network.

As indicated at step 2002, the UE capability Information including PQC information is sent from the UE 702 to the MN 712. A SN modification procedure for a set of bearers is initiated from the UE 702 to the MN 712 and the SN 714 for SN modification, as indicated at step 2004. The UE capability information is already assumed to be carrying the PQC support capability. Further, the MN 712 prepares the SN modification Request message including the UE capability and specifically security related elements to send to the SN 714. The SN modification request message is sent from the MN 712 to the SN 714 with the PQC information, as indicated at step 2006. The SN 714 evaluates the PQC information between the UE 702 and the SN 714 and sets the security parameters, as indicated at step 2008. If PQC is supported between the UE 702 and the SN 714, then an SN modification request acknowledge message is sent from the SN 714 to the MN 712, as indicated at step 2010. Else if PQC is not supported in the UE 702 or the SN 714, then an SN modification request reject message is sent from the SN 714 to the MN 712, as indicated at step 2012.

The MN 712 sends a RRC reconfiguration message (for example with 6G RRC reconfiguration and security configuration details) to the UE 702, on receiving the SN modification request acknowledge message, as indicated at step 2014. Further, the UE 702 sends an RRC reconfiguration complete message to the MN 712, as indicated at step 2016, after completion of reconfiguration based on the network data and one or more security parameters. The SN reconfiguration complete message is sent to the SN 714 from the MN 712, as indicated at step 2018. Further, bearers are set up between the UE 702, the MN 712, the SN 714, User Plane Function (UPF) 1202 and Access and Mobility Management Function (AMF) 1204, as indicated at step 2020, and data forwarding procedures are implemented.

FIG. 21 illustrates a message sequence diagram 2100 indicating PQC related security aspects in S6gNB modification procedure with EPC. For example, the message sequence diagram 2100 is a S6gNB modification procedure with the MN 712 as 4G and EPC network. As indicated at step 2102, the UE capability Information including PQC information is sent from the UE 702 to the MN 712. A S6gNB modification procedure for a set of bearers is initiated from the UE 702 to the MN 712 and the SN 714 for SN modification, as indicated at step 2104. The UE capability information is already assumed to be carrying the PQC support capability. Further, the MN 712 prepares the S6gNB modification Request message including the UE capability and specifically security related elements to send to the SN 714. The S6gNB modification request message is sent from the MN 712 to the SN 714 with the PQC information, as indicated at step 2106. The SN 714 evaluates the PQC information between the UE 702 and the SN 714 and sets the security parameters, as indicated at step 2108. If PQC is supported between the UE 702 and the SN 714, then an S6gNB modification request acknowledge message is sent from the SN 714 to the MN 712, as indicated at step 2110. Else if PQC is not supported in the UE 702 or the SN 714, then a S6gNB modification request reject message is sent from the SN 714 to the MN 712, as indicated at step 2112.

Further, the MN 712 sends a RRC reconfiguration message (for example with 6G RRC reconfiguration and security configuration details) to the UE 702, on receiving the S6gNB modification request acknowledge message, as indicated at step 2114. Further, the UE 702 sends an RRC reconfiguration complete message to the MN 712, as indicated at step 2116, after completion of reconfiguration based on the network data and one or more security parameters. Further, bearers are set up between the UE 702, the MN 712, the SN 714, S-GW 1302 and MME 1304, as indicated at step 2118, and data forwarding procedures are implemented.

### SN Modification Request:

In this solution, the SN Modification Request message shall include the PQC support related aspect. Following change is required to incorporate in the 3rd Generation partnership project (3GPP) OS 3x.423.

Table 36 depicts a SN modification request.

TABLE 36
S-NODE MODIFICATION REQUEST:
Direction: M-NG-RAN node -> S-6G RAN node

| IE/ | | | IE type | Semantics | | Assigned |
|---|---|---|---|---|---|---|
| Group | Pres- | | and | descript- | Criti- | Criti- |
| Name | ence | Range | reference | ion | cality | cality |
| PQC In- | M | | 9.2.3.X | | YES | reject |
| formation | | | | | | |

The SN modification request message is introduced with new IE, for PQC information as shown in Table 37.

TABLE 37

| | | | IE type and | |
|---|---|---|---|---|
| IE/Group Name | Presence | Range | reference | Semantics description |
| PQC Support | | | Legacy Only | PQC preferred supports |
| | | | PQC Only | both legacy and PQC |
| | | | PQC | securities while Legacy |
| | | | Preferred | only and PQC only |
| | | | | support only as name |
| | | | | suggests. |
| PQC Parameters | | | 9.2.3.X.n | When PQC is |
| | | | | supported, the related |
| | | | | parameters or al- |
| | | | | gorithms are shared as |
| | | | | in table 9.2.3.X.n |

Similarly, the following modification is required in 3GPP specification TS 3x.423. Table 38 depicts a S6gNB modification request.

TABLE 38
S6gNB MODIFICATION REQUEST
Direction: MeNB -> S6gNB

| IE/ | | | IE type | Semantics | | Assigned |
|---|---|---|---|---|---|---|
| Group | Pres- | | and | descrip- | Criti- | Criti- |
| Name | ence | Range | reference | tion | cality | cality |
| PQC In- | M | | 9.2.X | | YES | reject |
| formation | | | | | | |

The S6gNB modification request message is introduced with new IE, for PQC information as shown in Table 39.

TABLE 39

| IE/Group | | | IE type and | |
|---|---|---|---|---|
| Name | Presence | Range | reference | Semantics description |
| PQC | | | Legacy Only | PQC preferred supports both |
| Support | | | PQC Only | legacy and PQC securities |
| | | | PQC | while Legacy only and PQC |
| | | | Preferred | only support only as name |
| | | | | suggests. |
| PQC | | | 9.2.X.n | When PQC is supported, |
| Parameters | | | | the related parameters or |
| | | | | algorithms are shared |
| | | | | as in table 9.2.X.n |

The sections referred above 9.2.3.X.n and 9.2.X.n for corresponding specification (TS 3x.423), refers to Table 5.

Based on the SN modification request message contents, related to PQC, the SN 714 needs to evaluate the UE 702 and SN PQC support, and update the security parameters, and determine if the UE 702 is allowed to modify the SN 714 or not.

### Evaluation of PQC Support:

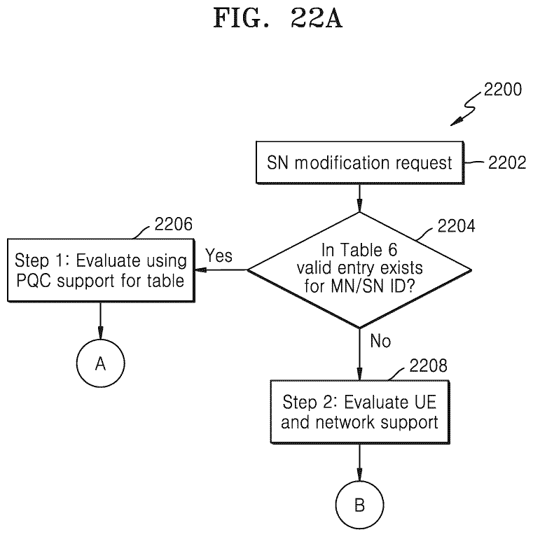

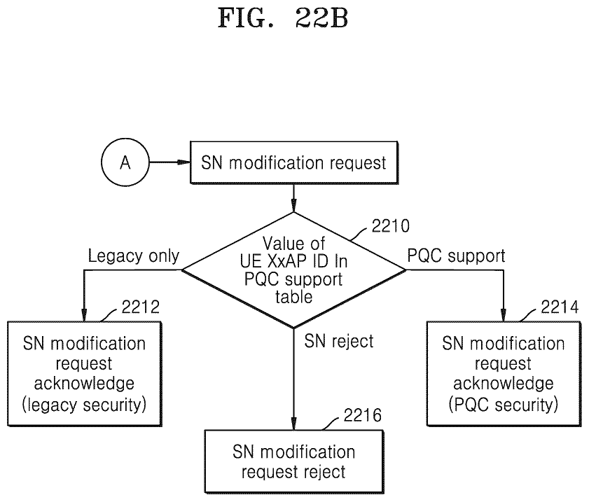

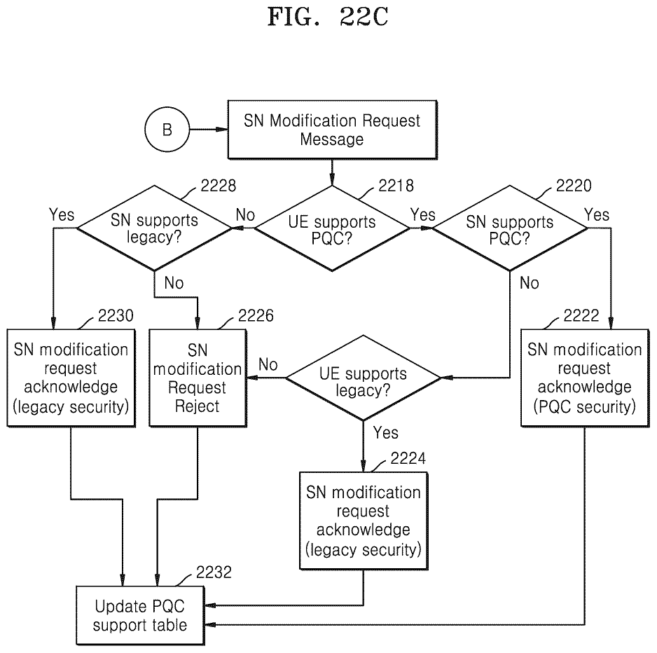

FIG. 22a illustrates a method 2200 for evaluating PQC information at SN 714 based on SN modification request message. Based on the SN modification request message contents received from the MN 712, related to PQC, the SN 714 needs to evaluate the UE 702 and SN 714 PQC support, update the security parameters, and determine if the UE 702 is allowed to modify the SN 714 or not. The SN modification request message, as depicted in step 2202, carries the PQC information including the PQC support and related PQC profile or associated PQC parameters or algorithms supported at UE 702 side.

The SN 714 verifies the PQC support table (Table 6) for valid entry of MN ID or SN ID, as depicted in step 2204. The method 2200 to evaluate the PQC support can be split into two steps as shown in the FIG. 22a. If a valid entry exists for the MN ID or SN ID, then the PQC support table (Table 6) is utilized to determine whether the given UE 702 and the SN 714 has matched or mismatched PQC capabilities according to step 1, as depicted in step 2206, based on SN modification procedure and accordingly a decision can be taken. If there is no valid entry for the UE 702 in the PQC support table, then step 2 can be evaluated for determining the PQC support between the UE 702 and the SN 714, as depicted in step 2208.

FIG. 22b illustrates a method of implementing step 1 of FIG. 22a where the PQC support table is utilized to determine whether the given UE 702 and the SN 714 has matched or mismatched PQC capabilities. The method is executed when there is a valid UE XxAP ID entry in the PQC support table. The value corresponding to the UE XxAP ID is evaluated and accordingly, the action is taken, as depicted in step 2210. If the value supports legacy only, then the SN modification request acknowledge with legacy security is sent from the SN 714 to the MN 712, as depicted in step 2212. If the value supports PQC, then the SN modification request acknowledge with PQC security is sent from the SN 714 to the MN 712, as depicted in step 2214. If the value is not supported, then a SN modification request reject is sent from the SN 714 to the MN 712, as depicted in step 2216.

FIG. 22c illustrates a method of implementing step 2 of FIG. 22a when there is no valid entry for the UE 702 in the PQC support table. The step 2 can be evaluated for determining the PQC support between the UE 702 and the SN 714. The SN modification request message is checked for UE PQC support. According to the proposed solution, the SN modification request carries the PQC information including the PQC support and related profile, or algorithms supported at the UE side. As a first step, the SN 714 shall determine if the UE supports PQC, as depicted in step 2218.

If the UE 702 supports PQC, then the SN 714 shall check if SN 714 supports PQC, as depicted in step 2220. If both the UE 702 and the SN 714 supports PQC, then the PQC is preferred, and the SN modification request acknowledge is sent with PQC as a preferred security method, as depicted in step 2222. If the UE 702 supports PQC and legacy, while the SN 714 does not support PQC, then the SN modification request acknowledge is sent with legacy security method, as depicted in step 2224. If the UE 702 supports PQC only and the SN 714 supports legacy only, then a SN modification request is rejected, as depicted in step 2226, due to mismatch in capabilities of the UE 702 and the SN 714.

Furthermore, if the UE 702 does not support PQC, then the SN 714 checks if it supports legacy, as depicted in step 2228. If the SN 714 supports legacy, then the SN modification request is acknowledged with legacy security, as depicted in step 2230. If the SN 714 supports PQC only, in that case, a mismatch occurs between the capabilities of the UE 702 and the SN 714, and hence, the SN modification is rejected, as depicted in step 2226. In order to further optimize the process, a table like Table 6 can be maintained to update the PQC support and that table can be referenced whenever the SN modification procedures are invoked, as depicted in step 2232.

SN/S6gNB Modification—further enhancements:

Security aspects for legacy based algorithms:

The following changes to specification TS 3x.423 is required to add the following:

### S-NODE MODIFICATION REQUEST:

This message is sent by the M-NG-RAN node to the S-6G-RAN node to either request the preparation to modify S-6G-RAN node resources for a specific UE, or to query for the current SCG configuration, or to provide the S-RLF-related information to the S-6G-RAN node. Table 40 shows the SN modification request.

TABLE 40
Direction: M-NG-RAN node -> S-6G-RAN node.

| IE/ | | | IE type | Semantics | | Assigned |
|---|---|---|---|---|---|---|
| Group | Pres- | | and | descrip- | Criti- | Criti- |
| Name | ence | Range | reference | tion | cality | cality |
| UE | | 0.1 | | | YES | reject |
| Context | | | | | | |
| In- | | | | | | |
| formation | | | | | | |
| >6G UE | O | | 9.2.3.X | | — | |
| Security | | | | | | |
| Capa- | | | | | | |
| bilitiess | | | | | | |
| >S-6G- | 0 | | 9.2.3.XX | | — | |
| RA | | | | | | |
| N node | | | | | | |
| Security | | | | | | |
| Key | | | | | | |

### S6GNB MODIFICATION REQUEST:

This message is sent by the MeNB to the S6gNB to request the preparation to modify S6gNB resources for a specific UE, to query for the current SCG configuration, or to provide the S-RLF-related information to the S6gNB. Table 41 shows the S6gNB modification request.

TABLE 41
Direction: MeNB -> S6gNB

| IE/ | | | IE type | Semantics | | Assigned |
|---|---|---|---|---|---|---|
| Group | Pres- | | and | descrip- | Criti- | Critic- |
| Name | ence | Range | reference | tion | cality | ality |
| UE Context | | 0.1 | | | YES | reject |
| In- | | | | | | |
| formation | | | | | | |
| >6G UE | O | | 9.2.X | | — | |
| Security | | | | | | |
| Capa- | | | | | | |
| bilities | | | | | | |
| >S6gNB | O | | 9.2.XX | | — | |
| Security | | | | | | |
| Key | | | | | | |

In both the sections 9.2.3.X and 9.2.X, 6G related encryption and integrity protection algorithms are included, as shown in the table 42.

TABLE 42

| IE/Group | | | IE Type | Semantics |
|---|---|---|---|---|
| Name | Presence | Range | and Reference | Description |
| 6G | | | BIT STRING | Each position |
| Encryption | | | (6G encryption | in the bitmap |
| Algorithms | | | algorithm1, | represents an |
| | | | 6G encryption | encryption |
| | | | algorithm2, 6G | algorithm |
| | | | encryption | |
| | | | algorithm3 | |
| | | | etc . . . ) | |
| 6G Integrity | | | BIT STRING (6G | Each position |
| Protection | | | Integrity algorithm1, | in the |
| Algorithms | | | 6G Integrity | bitmap |
| | | | algorithm2, 6G | represents an |
| | | | Integrity algorithm3.. | encryption |
| | | | Etc) | algorithm |

Enhancements to CG-ConfigInfo included in SN modification request message:

In specification, TS 3x.331 SN/S6GNB modification request message has a container to carry CG-ConfigInfo as shown below.

### S-NODE MODIFICATION REQUEST

This message is sent by the M-NG-RAN node to the S-6G-RAN node to either request the preparation to modify S-6G-RAN node resources for a specific UE, or to query for the current SCG configuration, or to provide the S-RLF-related information to the S-6G-RAN node. Table 43 shows the SN modification request.

TABLE 43
Direction: M-NG-RAN node -> S-6G-RAN node.

| IE/ | | | IE type | Semantics | | Assigned |
|---|---|---|---|---|---|---|
| Group | Pres- | | and | descrip- | Criti- | Critic- |
| Name | ence | Range | reference | tion | cality | ality |
| M-NG- | O | | OCTET | Includes | YES | ignore |
| RAN | | | STRING | the CG- | | |
| node to | | | | ConfigInfo | | |
| S-6G- | | | | message as | | |
| RAN | | | | defined in | | |
| node | | | | subclause | | |
| Con- | | | | 11.2.2. | | |
| tainer | | | | of TS 38.331 | | |
| | | | | [10]. | | |

### S6gNB MODIFICATION REQUEST

This message is sent by the MeNB to the S6gNB to request the preparation to modify S6gNB resources for a specific UE, to query for the current SCG configuration, or to provide the S-RLF-related information to the S6gNB. Table 44 shows the S6gNB modification request.

TABLE 44
Direction: MeNB -> S6gNB

| IE/ | | | IE type | Semantics | | Assigned |
|---|---|---|---|---|---|---|
| Group | Pres- | | and | descrip- | Criti- | Critic- |
| Name | ence | Range | reference | tion | cality | ality |
| MeNB | O | | OCTET | Includes | YES | reject |
| to | | | STRING | the CG- | | |
| S6gNB | | | | ConfigInfo | | |
| Con- | | | | message | | |
| tainer | | | | as defined | | |
| | | | | in TS | | |
| | | | | 38.331 | | |
| | | | | [31]. | | |

CG-ConfigInfo is further defined as following Table 45.

TABLE 45
-- ASNISTART
-- TAG-CG-CONFIG-INFO-START
CG-ConfigInfo ::= SEQUENCE {
. . .
CG-ConfigInfo-IEs ::= SEQUENCE {
. . .
sourceConfigSCG OCTET STRING
(CONTAINING RRCReconfiguration)
OPTIONAL,
}
CG-ConfigInfo-v1560-IEs ::= SEQUENCE {
sourceConfigSCG-EUTRA OCTET STRING
OPTIONAL,
}
CG-ConfigOInfo-VXX-IEs :: = SEQUENCE {
SourceConfigSCG-6G OCTET STRING OPTIONAL,
}
-- TAG-CG-CONFIG-INFO-STOP
-- ASNISTOP

Table 46 shows CG-ConfigInfo.

TABLE 46

| | sourceConfigSCG-EUTRA- | sourceConfigSCG- |
|---|---|---|
| sourceConfigSCG-NR | EUTRA | 6G-for 6G RAT |
| Includes all of the | Includes the E-UTRA RRCConnec- | Includes all of the |
| current SCG config- | tionReconfiguration message as | current SCG config- |
| urations used by the | specified in TS 36.331 [10]. In this | urations used by the |
| target SN to build delta | version of the specification, the E- | target SN to send to |
| configuration to be sent | UTRA RRC message can only | UE. During SN |
| to UE, e.g. during SN | include the field scg-Configuration. | Change. The field |
| change. The field | In this version of the specification, | contains the RRC re- |
| contains the RRCRecon- | this field is absent when master gNB | configuration-6G |
| figuration message, i.e. | uses full configuration option. This | message as will be |
| including sec- | field is only used in NE-DC. | defined in 6G RRC |
| ondaryCellGroup and | | specification. This |
| measConfig. The field is | | will be used for |
| signalled upon change of | | |
| SN, unless MN uses full | | |
| configuration option. | | |
| Otherwise, the field is | | |
| absent. | | |

The SN modification request acknowledge contains the following IE as shown in table 47.

TABLE 47
S-NODE MODIFICATION REQUEST ACKNOWLEDGE
Direction: S6gNB -> MgNB

| IE/ | | | IE type | Semantics | | Assigned |
|---|---|---|---|---|---|---|
| Group | Pres- | | and | descrip- | Criti- | Criti- |
| Name | ence | Range | reference | tion | cality | cality |
| S-NG- | M | | OCTET | Includes | YES | reject |
| RAN | | | | the CG- | | |
| node to | | | STRING | Config | | |
| MNG- | | | | message | | |
| RAN | | | | orthe CG- | | |
| node | | | | CandidateList | | |
| Con- | | | | message as | | |
| tainer | | | | defined | | |
| | | | | in subclause | | |
| | | | | 11.2.2 | | |
| | | | | of TS | | |
| | | | | 3x.331 [10]. | | |

The S6gNB modification request acknowledge contains the following IE as shown in table 48.

TABLE 48
S6gNB MODIFICATION REQUEST ACKNOWLEDGE
Direction: S6gNB -> MeNB

| | | | IE type | Seman- | | As- |
|---|---|---|---|---|---|---|
| IE/ | P | | and | tics | | signed |
| Group | res- | | refer- | descrip- | Criti- | Criti- |
| Name | ence | Range | ence | tion | cality | cality |
| SgNB | M | | OCTET | Includes the | YES | reject |
| to | | | STRING | CG-Config | | |
| MeNB | | | | message or | | |
| Cont- | | | | the CG- | | |
| ainer | | | | CandidateList | | |
| | | | | message, as | | |
| | | | | defined in | | |
| | | | | TS | | |
| | | | | 3x.331[31]. | | |

The CG-Config may be represented as following Table 49:

TABLE 49
CG-Config
-- ASNISTART
-- TAG-CG-CONFIG-START
CG-Config ::= SEQUENCE {
. . .
CG-Config-v1540-IEs ::= SEQUENCE {
pSCellFrequency ARFCN-ValueNR OPTIONAL,
}
CG-Config-v1560-IEs ::= SEQUENCE {
pSCellFrequencyEUTRA ARFCN-ValueEUTRA OPTIONAL,
CG-Config-vXX-IEs ::= SEQUENCE {
pSCellFrequency6G 6G-ARFCN OPTIONAL,
}
-- TAG-CG-CONFIG-STOP
-- ASNISTOP

Table 50 shows the pSCell frequencies.

TABLE 50

| pSCellFrequency-NR | pSCellFrequencyEUTRA-EUTRA | pSCellFrequency6G-6G |
|---|---|---|
| candidateCellInfoListSN | candidateCellInfoListSN- | candidateCellInfoListSN- |
| OCTET STRING | EUTRA | 6GOCTET-STRING |
| (CONTAINING | OCTET STRING | OPTIONAL, |
| MeasResultList2NR) | OPTIONAL, | |
| OPTIONAL, | | |

The pSCellFrequency, pSCellFrequencyEUTRA, pSCellFrequency6G indicates the frequency of PSCell in NR (i.e., pSCellFrequency) or E-UTRA (i.e., pSCellFrequencyEUTRA) or 6G(pSCellFrequency6G).

The proposed systems 700 and methods provide inclusion of new information elements for measurement aspects in SN and S6gNB addition request message, or SN and S6gNB modification request message for 6G or next generation networks, inclusion of new information elements for UE capability aspects in SN and S6gNB addition request message, or SN and S6gNB modification request message for 6G or next generation networks, and inclusion of new information elements for legacy security aspects in SN and S6gNB addition request message, or SN and S6gNB modification request message for 6G or next generation networks. The systems 700 and methods provide a PQC algorithm support factor to be considered for SN addition, SN modification and conditional SN addition procedures, and a PQC support information which can be shared between the MN 712 and SN 714 nodes during SN procedures related to the UE 702. The proposed method provides evaluation of PQC support using the PQC support information exchanged between the MN 712 and SN 714. Further, optimization of method to evaluate PQC support is disclosed by maintaining a reference table or database between thee MN 712 and SN 714 nodes regarding type of security algorithm supported at UE 702. The proposed method provides SN addition request acknowledgement or SN modification request acknowledgement procedures to include new information elements for 6G or next generation network RAT and PQC aspects. The methods provide UE side procedure updates for SN addition or modification due to 6G or next generation network RAT. The methods provide addition of new cause to handle PQC at SN rejection. The methods provide new information elements which are added to handle 6G or next generation network RAT at CPA procedure. The methods further provide new aspects related to UE initiated SN addition procedure.

The embodiments disclosed herein can be implemented through at least one software program running on at least one hardware device and performing network management functions to control the network elements. The network elements shown in FIG. 7 include blocks which can be at least one of a hardware device, or a combination of hardware device and software module.

The embodiment disclosed herein describes systems 700 and methods to provide SN addition, SN modification, and conditional SN addition procedures to handle NSA option when 6G or next generation network RAT is introduced, and to handle new and improved security algorithms that are quantum computational capabilities resistant.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of embodiments and examples, those skilled in the art will recognize that the embodiments and examples disclosed herein can be practiced with modification within the scope of the embodiments as described herein.

1. A method for handling Secondary Node (SN) addition in Multi Radio Access Technology (RAT)-Dual Connectivity (MR-DC) performed by a Master Node (MN) in a wireless communication system, the method comprising:
receiving at least one User Equipment (UE) capability information from at least one UE, wherein the at least one UE capability information comprises a Post Quantum Cryptography (PQC) information;
transmitting an SN addition request message to at least one SN with the PQC information, based on the at least one UE capability information;
receiving an SN addition request acknowledge message from the at least one SN, if PQC is supported between the at least one UE and the at least one SN; and
receiving an SN addition request reject message from the at least one SN, if PQC is not supported between the at least one UE and the at least one SN.

2. The method of claim 1, wherein the SN addition request message comprises information of one or more candidate cells, wherein the information of the one or more candidate cells comprises measurement results of one or more node parameters of one or more SNs for choosing and configuring the at least one SN.

3. The method of claim 1, wherein the SN addition request message comprises the at least one UE capability information and a UE capability co-ordination result, wherein the at least one UE capability information comprises a Radio Access Technology (RAT) information including 6G RAT.

4. The method of claim 1, wherein the PQC information comprises at least one PQC support, and at least one PQC profile or associated PQC parameters, wherein the at least one PQC support indicates whether the at least one UE supports at least one of PQC, a legacy security method, and both PQC and the legacy security method, and the at least one PQC profile or associated PQC parameters indicates if a relevant mechanism is supported at the UE side for the at least one PQC support.

5. The method of claim 4, wherein the legacy security method comprises at least one security support for the one or more SNs of the network, wherein the at least one security support comprises at least one of one or more security capabilities and one or more security keys.

6. The method of claim 1, wherein a PQC support table is configured and maintained at at least one of the MN and the at least one SN to evaluate the PQC information between the at least one UE and the at least one SN by the at least one of the MN and the at least one SN, wherein the PQC support table comprises one or more values indicating the PQC information between the at least one UE and the at least one SN.

7. The method of claim 6, further comprising:
evaluating, by the MN, the PQC support table for the one or more SNs, for executing a Conditional PSCell Addition (CPA) procedure;
transmitting, by the MN, at least one SN addition request message to the at least one SN based on the evaluation, and receiving at least one SN addition request acknowledge message for the at least one SN addition request message; and
transmitting, by the MN, a Radio Resource Control (RRC) reconfiguration message including information of the one or more SNs for the received at least one SN addition request acknowledge message, to the at least one UE for enabling the at least one UE to evaluate a conditional configuration for the one or more SNs.

8. The method of claim 1, wherein the SN addition request acknowledge message comprises at least one of an RRC reconfiguration information related to the at least one SN of the network, and a global cell identity of the at least one SN of the network for executing the CPA procedure by the at least one UE.

9. A Master Node (MN) of a network, comprising:
a processor, configured to:
receive at least one User Equipment (UE) capability information from at least one UE, wherein the at least one UE capability information comprises a Post Quantum Cryptography (PQC) information;
send an SN addition request message to at least one SN with the PQC information, based on the at least one UE capability information;
receive an SN addition request acknowledge message from the at least one SN, if PQC is supported between the at least one UE and the at least one SN; and
receive an SN addition request reject message from the at least one SN, if PQC is not supported between the at least one UE and the at least one SN.

10. The MN of claim 9, wherein the SN addition request message comprises information of one or more candidate cells, wherein the information of the one or more candidate cells comprises measurement results of one or more node parameters of one or more SNs for choosing and configuring the at least one SN.

11. The MN of claim 9, wherein the SN addition request message comprises the at least one UE capability information and a UE capability co-ordination result, wherein the at least one UE capability information comprises a Radio Access Technology (RAT) information including 6G RAT.

12. The MN of claim 9, wherein the PQC information comprises at least one PQC support, and at least one PQC profile or associated PQC parameters, wherein the at least one PQC support indicates whether the at least one UE supports at least one of PQC, a legacy security method, and both PQC and the legacy security method, and the at least one PQC profile or associated PQC parameters indicates if a relevant mechanism is supported at the UE side for the at least one PQC support.

13. The MN of claim 12, wherein the legacy security method comprises at least one security support for the one or more SNs of the network, wherein the at least one security support comprises at least one of one or more security capabilities and one or more security keys.

14. The MN of claim 9,
wherein a PQC support table is configured and maintained at least one of the MN and the at least one SN to evaluate the PQC information between the at least one UE and the at least one SN by the at least one of the MN and the at least one SN, wherein the PQC support table comprises one or more values indicating the PQC information between the at least one UE and the at least one SN, and
wherein the processor of the MN is configured to:
evaluate the PQC support table for the one or more SNs, for executing a Conditional PSCell Addition (CPA) procedure;
transmit at least one SN addition request message to the at least one SN based on the evaluation, and receive at least one SN addition request acknowledge message for the at least one SN addition request message; and
transmit a Radio Resource Control (RRC) reconfiguration message including information of the one or more SNs for the received at least one SN addition request acknowledge message, to the at least one UE for enabling the at least one UE to evaluate a conditional configuration for the one or more SNs.

15. The MN of claim 9, wherein the SN addition request acknowledge message comprises at least one of an RRC reconfiguration information related to the at least one SN of the network, and a global cell identity of the at least one SN of the network for executing the CPA procedure by the at least one UE.
